(19) United States
(12) Patent Application Publication
(10) Pub. No.: US 2026/0264416 A1
(43) Pub. Date: Sep. 10, 2026

(54) PRINT CORRECTION METHOD AND DROPLET EJECTION HEAD THEREFOR

(71) Applicant: AXALTA COATING SYSTEMS IP CO., LLC, Wilmington, DE (US)

(72) Inventors: Michael S. Wolfe, Wilmington, DE (US); Shih-Wa Wang, Glen Mills, PA (US); Cameron L. Stevens, Philadelphia, PA (US); John R. Moore, Lansdale, PA (US); Nicholas Marc Jackson, Cambridge (GB); Angus Condie, New Castle (GB)

(73) Assignee: AXALTA COATING SYSTEMS IP CO., LLC, Wilmington, DE (US)

(21) Appl. No.: 19/491,284

(22) PCT Filed: Jun. 21, 2024
(86) PCT No.: PCT/US2024/035032

§ 371 Date: Dec. 8, 2025

Related U.S. Application Data
(60) Provisional application No. 63/509,938, filed on Jun. 23, 2023.

(51) Int. Cl. B41J 3/407; B41J 11/00; B41M 5/00; G01B 21/08; G01B 21/30; G06K 15/02; G06K 15/10

(52) U.S. Cl. CPC B41J 3/4073; B41J 11/0095; B41M 5/0088; G01B 21/08; G01B 21/30; G06K 15/021; G06K 15/102; G06K 15/1823

(57) ABSTRACT

A method of ejecting droplets of fluid to compensate for thickness variation due to on-substrate fluid flow of a dried uncompensated layer is disclosed. The method comprises a) receiving uncompensated image data and a predefined nominal thickness; b) determining the thickness variation from said predefined nominal thickness at one or more locations on a substrate of one or more dried uncompensated layers; c) determining compensating image data to compensate for said thickness variation; and d) ejecting droplets of fluid through one or more nozzles of a droplet ejection head using said compensating image data to form a dried compensated layer on said substrate. A droplet ejection apparatus for implementing the method is also disclosed, and comprises one or more droplet ejection heads mounted on one or more movement devices.

### CROSS-REFERENCE TO RELATED APPLICATION

This application claims priority to U.S. Provisional Application No. 63/509,938, filed Jun. 23, 2023, the contents of which are incorporated herein by reference.

### FIELD OF THE DISCLOSURE

The present disclosure relates to a print correction method and a droplet ejection head therefor. It may find particularly beneficial application in a printhead, such as an inkjet printhead.

### BACKGROUND

Droplet ejection heads are now in widespread usage, whether in more traditional applications, such as inkjet printing, or in 3D printing, or other rapid prototyping techniques. Accordingly, the fluids, e.g., inks, may have novel chemical properties to adhere to new substrates and increase the functionality of the deposited material. Droplet ejection heads have been developed that are capable of use in industrial applications, for example for printing directly onto substrates such as ceramic tiles or textiles or to form elements such as colour filters in LCD or OLED displays for flat-screen televisions. Such industrial printing techniques using droplet ejection heads allow for short production runs, customization of products and even printing of bespoke designs. It will therefore be appreciated that droplet ejection heads continue to evolve and specialise so as to be suitable for new and/or increasingly challenging applications. However, while a great many developments have been made in the field of droplet ejection heads, there remains room for improvements.

In recent years, there is increasing interest in printing onto more complex and/or large shapes, such as three-dimensional objects, or surfaces such as walls, or onto objects such as vehicles, such surfaces are herein referred to as complex substrates. Printing onto such complex substrates may comprise printing onto one or more of surfaces that are non-horizontal, for example, vertical surfaces, surfaces at an angle to the horizontal, curved surfaces and complex shapes comprising a number of differently oriented surfaces. Previously, some of these complex substrates have been coated using techniques such as spray painting, but this can be undesirable due to the release of large numbers of small particles of fluid into the atmosphere, which may be difficult or expensive to deal with so as to prevent environmental damage or harm to operators. Printing onto complex and/or large shapes and surfaces using droplet ejection heads is therefore of interest due to the ability to print onto the surface in a targeted and controlled manner, without release of large numbers of small particles into the surrounding area, which may require costly mitigation measures for operator safety of environmental reasons, for example. Such a technique may also reduce the fluid volume requirements, and therefore the associated fluid costs. Further, printing techniques may allow the use of multiple colours or fluid types at once, and the printing of complicated print jobs (such as images) in a limited number of passes. Printing onto complex substrates may, for example, require the use of industrial robots such as multi-axis machines and/or a gantry system and/or robotic arms.

There has also been increasing interest in printing thicker layers such as surface treatments and/or coatings. There has also been interest in printing thicker regions to produce, for example, raised features such as electronic circuits on circuit boards. There has also been interest in printing raised features such as tactile features and/or textures and/or three-dimensional ornamentations. Printing thicker layers or features onto a surface may be achieved by printing multiple thinner layers, for example using multiple passes of a droplet ejection head. But for reasons of time-saving and efficiency, or due to bonding problems between multiple layers, for example, it may be desirable to use droplet ejection heads that can print much thicker layers in a single pass. For example, a typical graphics print layer (e.g., images or text) may be 5 μm thick, whilst a paint layer (e.g., on a vehicle) may be at least 25 μm for durability and appearance reasons.

There is also increasing interest in combining the above-described end-uses to print a thicker overall covering or surface treatment onto a complex substrate, or to decorate and/or customise a complex substrate with images and/or text and/or texture.

A disadvantage of printing thicker layers and printing onto complex substrates, particularly in cases where the use of slow-drying fluids is required is that the fluid may have time to experience significant flow before it has dried, leading to a disparity between the desired location and/or thickness of the fluid and its final dried location. It may be understood that ‘slow-drying’ potentially means several minutes drying time, as opposed to, for example, UV curable inks which may be ‘dry’ (cured) in seconds. For example, fluids printed onto complex substrates may be subject to the effect of gravity where surfaces are non-horizontal, such the fluids flow on the complex substrate before they dry, leading to variation in the thickness of the dried printed layer or region on the surface and/or to dribbles or other artefacts outside the printed layer or region. This may be undesirable for aesthetic reasons (for example visible artefacts, such as surface undulations on the printed layer, or dribbles below the desired printed region) and/or for technical reasons (for example, a rust-proof surface treatment may be too thin to be effective in some regions and it may be too thick and readily chipped in other regions).

It may readily be understood that printing onto larger areas, whether horizontal or a complex substrate, may require printing multiple swathes to cover the whole area, e.g., it may comprise one or more heads moving back and forth to gradually cover the region, with a given head producing one print swathe (strip) with each pass. In an ideal situation, the first of any two adjacent swathes would be constrained to the desired print region where the droplets were deposited, such that the second of the two adjacent swathes would be adjacent to and touching the first, as shown in FIG. 2B. In reality, particularly if the fluid is slow-drying or slow-curing, or the layer of fluid is relatively thick, then fluid flow may occur prior to the first swathe drying, curing and/or setting, such that it extends beyond the desired first swathe print region (see FIG. 2B). When the second, adjacent, swathe is subsequently printed it may therefore overlay part of the first, forming a bulge on the surface (see FIG. 2C). Such an effect may be more or less pronounced depending on a number of factors, such as fluid viscosity, drying time, layer thickness, etc., This effect may be undesirable if it causes observable thickness variations, or affects the mechanical properties of the final layer, or the image quality. It may be generally understood that the effect may be seen when printing multiple swathes where a subsequent swathe is deposited adjacent to a previous swathe.

Some applications may overcome the above-described problem by using fluids that are fast-drying or fast-curable, e.g., are printed and then set or cured almost immediately afterwards, such as UV curable inks. Other applications may only require a thin printed layer (order of 5-10 μm) that dries quickly by virtue of the small volumes of fluid involved, for example for printing images or patterns. However, there are still many applications that require the use of fluids that are not fast-drying or not curable shortly after printing and/or where it is desirable to print thicker layers, such as for surface coatings or treatments, or to form raised features on a surface, for example for printing electronic components, or tactile features, or for decorative reasons, such layers may be of the order of 25-100 μm thick. Such applications may be subject to undesirable flow-induced thickness variations.

### BRIEF SUMMARY

The present embodiments are directed to mitigating flow-induced thickness variation, so as to produce a more uniform print thickness, thereby reducing or overcoming the above-described disadvantages of on-substrate fluid flow.

Aspects of the disclosure are set out in the appended independent claims, while particular embodiments are set out in the appended dependent claims.

A method of ejecting droplets of fluid to compensate for thickness variation due to on-substrate fluid flow of a dried uncompensated layer is provided. The method comprises:
a) receiving uncompensated image data and a predefined nominal thickness;
b) determining the thickness variation from said predefined nominal thickness at one or more locations on a substrate of one or more dried uncompensated layers;
c) determining compensating image data to compensate for said thickness variation; and
d) ejecting droplets of fluid through one or more nozzles of a droplet ejection head using said compensating image data to form a dried compensated layer on said substrate.

A droplet ejection apparatus for implementing the method is also provided. The droplet ejection apparatus comprises one or more droplet ejection heads and one or more movement devices, wherein said one or more droplet ejection heads are mounted on said one or more movement devices.

### BRIEF DESCRIPTION OF THE DRAWINGS

The embodiments of the present disclosure are set forth below and may be described with reference to the drawings, some of which are representational only and are not to scale, and in which:

FIG. 1A depicts a schematic cross-section through a standard array of droplets on a complex substrate that is inclined at an angle to the horizontal.

FIG. 1B depicts schematically a dried desired swathe on the complex substrate of FIG. 1A after the standard array of droplets of FIG. 1A have merged and dried.

FIG. 1C depicts a schematic cross-section through an uncompensated swathe on the complex substrate of FIG. 1A after the standard array of droplets of FIG. 1A have merged and dried.

FIG. 1D depicts a schematic cross-section through a second, different, uncompensated swathe to that of FIG. 1C.

FIG. 1E depicts a schematic cross-section through a compensated array of droplets to address the uncompensated swathe of FIG. 1C.

FIG. 1F depicts a schematic cross-section through a compensated array of droplets to address the uncompensated swathe of FIG. 1D.

FIG. 2A depicts a schematic cross-section through two dried desired swathes arranged adjacent to each other on a horizontal substrate.

FIG. 2B depicts a schematic cross-section through a first uncompensated swathe arranged on the horizontal substrate of FIG. 2A.

FIG. 2C depicts a schematic cross-section through adjacent first and second uncompensated swathes arranged on the horizontal substrate of FIG. 2A.

FIG. 2D depicts a schematic cross-section through the first uncompensated swathe of FIG. 2B arranged on the horizontal substrate of FIG. 2A and a compensated array of droplets to compensate for the second uncompensated swathe of FIG. 2C.

FIG. 2E depicts a schematic cross-section through the first uncompensated swathe of FIG. 2B and a second compensated swathe formed from the compensated array of droplets of FIG. 2D, both swathes arranged adjacent to each other on the horizontal substrate of FIG. 2A.

FIG. 3A depicts a schematic cross-section through first and second uncompensated swathes arranged on a non-horizontal substrate similar to that of FIG. 1A.

FIG. 3B depicts a schematic cross-section through a first compensated array of droplets on the non-horizontal substrate of FIG. 3A.

FIG. 3C depicts a schematic cross-section through a first compensated swathe formed from the first compensated array of droplets of FIG. 3B and a second compensated array of droplets, both arranged on the non-horizontal substrate of FIG. 3A.

FIG. 3D depicts a schematic cross-section through the first compensated swathe of FIG. 3C and a second compensated swathe formed from the second compensated array of droplets of FIG. 3C, both arranged on the non-horizontal substrate of FIG. 3A.

FIG. 3E depicts a schematic cross-section through the first and second uncompensated droplet arrays.

FIG. 4A depicts a schematic cross-section through a dried uncompensated layer on a multiple-surface complex substrate.

FIG. 4B depicts a schematic cross-section through a dried compensated layer on the multiple-surface complex substrate of FIG. 4A.

FIG. 5 depicts an apparatus addressing a complex substrate, wherein the apparatus comprises a fluid supply system, a movement device and a droplet ejection head connected to the fluid supply system and mounted on the movement device;

FIG. 6 is a schematic representation of a multi-axis, multi-arm droplet ejection apparatus comprising a plurality of droplet ejection heads to address a convex complex substrate.

FIG. 7 is a diagram of the method steps to measure and compensate for thickness variation due to on-substrate fluid flow.

FIG. 8 is a diagram of the method steps to determine and compensate for thickness variation due to on-substrate fluid flow and print onto a substrate.

FIGS. 9A and 9B are illustrations of photographs taken during an assessment of coating layers prepared in Example 1, with an uncompensated layer (FIG. 9A) and a compensated layer (FIG. 9B) showing relative sag performance.

FIGS. 10A and 10B depict visible conditions used to assess defects in the coating layers prepared in Examples 2-11, with FIG. 10A showing a representative light distortion indicative of a defect on a dried layer resulting in a lower (negative) rating, and FIG. 10B showing a representative non-distorted light pattern indicative of a lesser/reduced defect on a dried layer resulting in a higher (positive) rating.

Where appropriate, like reference numerals have been used for like features.

### DETAILED DESCRIPTION

The following detailed description is merely exemplary in nature and is not intended to limit the instant disclosure. Furthermore, there is no intention to be bound by any theory presented in the preceding background or the following detailed description.

In general, the present disclosure provides methods of preparing coatings and coated articles, e.g. methods of applying coating compositions onto a substrate (e.g. to form a coating thereon), coating compositions useful in the methods, and coated articles prepared by such application methods. The present disclosure further provides devices and systems for carrying out the methods and/or utilizing the coating compositions in the manner described.

For the sake of brevity, well known conventional techniques related to the compositions, methods, processes, devices, systems, and articles, as well as various portions and components thereof, may be introduced or otherwise set forth in the embodiments herein with varying levels of description. For example, conventional techniques related to formation of the coating compositions may not be described in detail herein, as the various steps in the manufacture of such compositions are well-known and will be readily understood and envisaged by those of skill in the art in view of the embodiments and examples provided herein. Similarly, various tasks and process steps described herein may be incorporated into a more comprehensive procedure or process having additional steps or functionality not otherwise described, e.g. for being well-known and readily appreciated by those of skill in the art. Such conventional steps may only be mentioned briefly or may be omitted entirely without providing well-known process details.

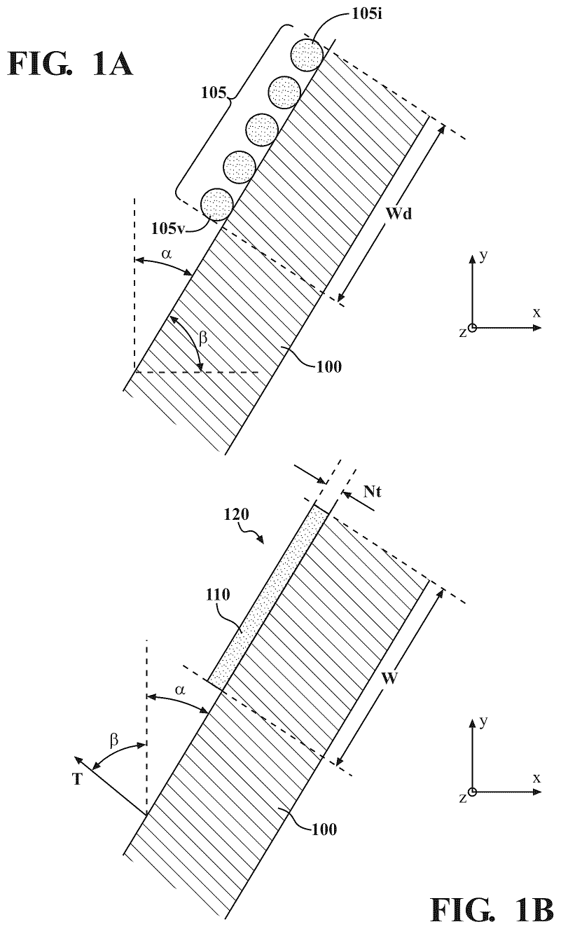

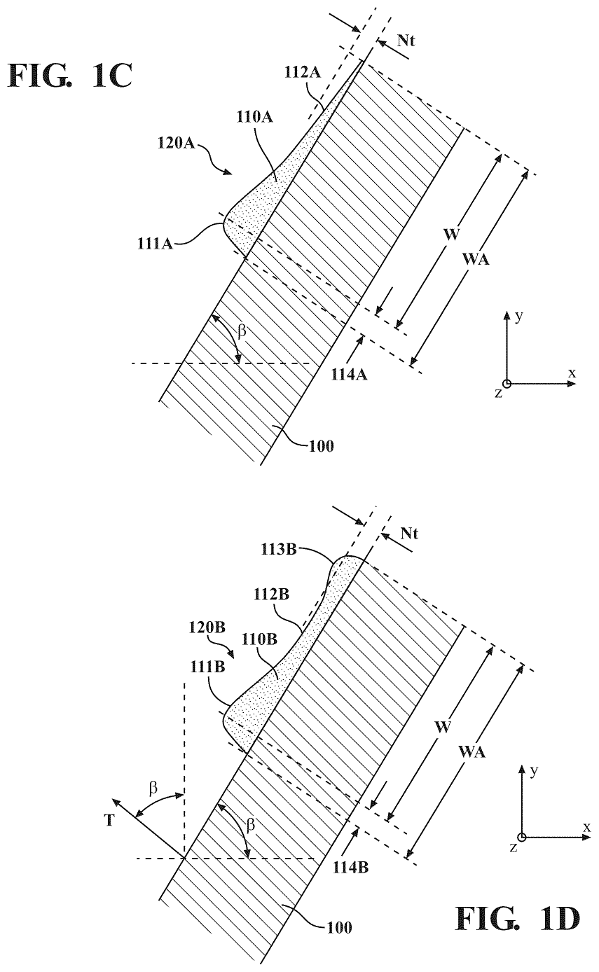

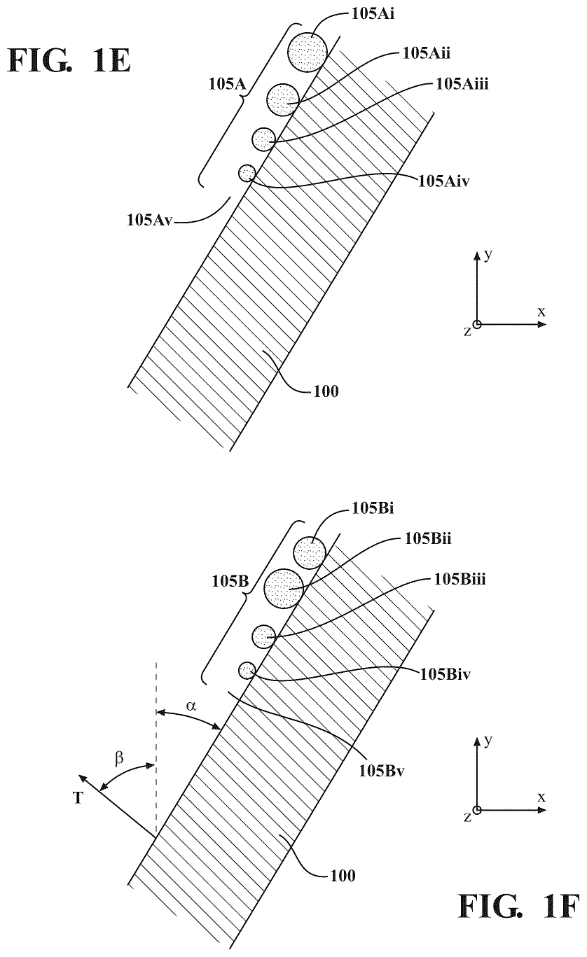

Considering first to FIG. 1A, shown is a schematic cross-section through a standard array of droplets 105 on a complex substrate 100 that is inclined at an angle β to the horizontal. It may be understood that the complex substrate 100 extends into the page (not shown) in the z-direction and that the droplets have been ejected from a droplet ejection head traversing over the complex substrate 100. The swathe has a width W, which depends on the width of the row(s) of nozzles on the droplet ejection head. It may be understood that the droplet ejection head may comprise a plurality of nozzles, and may be able to eject large numbers of droplets at any given time instance, but for simplicity, FIG. 1A depicts only a few droplets 105i-105v.

An example of such a droplet ejection head is a shared wall head, in which opposing walls are formed from a sheet of piezoelectric material into which parallel grooves have been sawn to form pressure chambers. In such a device, the pressure chambers are arranged in parallel side by side and each pressure chamber is fluidically connected to one or more nozzles. The walls of the pressure chambers are actuable to eject one or more droplets of fluid through the nozzles in accordance with print instructions. Individual pressure chambers are individually addressable so as to control whether or not a droplet is ejected as per the print instructions. The pressure chambers in grey-scale enabled droplet ejection heads are further addressable to control the volume of fluid ejected via a given nozzle.

Turning now to FIG. 1B, this depicts schematically a dried desired swathe 110 on the complex substrate 100 after the droplets of FIG. 1A have merged and dried. The dried desired swathe 110 has a nominal thickness Nt, measured perpendicular to the surface of the complex substrate 100 in the thickness direction T (it may be generally understood that depending on the shape of the complex substrate 100, T may be a constant direction, or may vary in orientation as the surface orientation of the complex substrate changes). It may be generally understood that depending on the type of fluid deposited, the volume of the dried swathe or layer may be similar to the volume of fluid deposited on it (for example where the fluid forms chemical cross-links or “cures” with little volume loss). Alternatively, the volume of the dried desired swathe 110 may be less than that of the volume of droplets deposited to form it, for example, the fluid may comprise carrier fluids that evaporate in full or in part once the fluid has been deposited on the substrate. Such carrier fluids may be water, or solvents, for example. Still further, depending on the deposited fluid, some processes, such as curing, may cause the polymerizing molecules, to move closer together, causing shrinkage in the volume of the dried swathe compared to the un-dried swathe.

It may be understood that UV curable inks, for example, do not ‘dry’ but instead polymerize (cure) in UV light and become solid. In comparison, inks and paints generally ‘dry’ by losing liquid mass/volume and leaving behind the solid contents (and sometimes resins). It may be generally understood that the term dried as used herein, for example “dried swathe” or “dried layer” may encompass any processes where a liquid, such as an ink or varnish or paint or other fluid-at-time-of-deposition liquid may be deposited on a substrate and undergo a process to form a desired non-liquid layer or coating on the substrate (e.g. a surface treatment or coating or decorative layer, or textural treatment, etc.). Such processes may include drying by evaporative loss of fluid, by curing, by chemical bonding once deposited on the substrate, etc.

FIG. 1C and FIG. 1D are schematic cross-sections through two different dried uncompensated swathes 110A, 110B forming a dried uncompensated layer 120 on the complex substrate 100 of FIG. 1A, after an uncompensated array of droplets 105, as shown in FIG. 1A, have merged and dried. In both cases, the fluid has flowed on the complex substrate 100 under the influence of gravity prior to setting or drying. In FIG. 1C the fluid has flowed such that the distorted layer 110A has a decreased thickness 112A at the top end, which is less than the nominal thickness Nt, and an increased thickness 111A at the bottom end, which is greater than the nominal thickness Nt. In FIG. 1D the fluid has flowed such that there is an increased thickness 113B at the top end (for example due to meniscus pinning at the top end), a decreased thickness 112B in the middle and an increased thickness 111B at the bottom end. It can also be seen that in both cases the fluid has flowed beyond (below) the extent of the dried desired swathe 110, such that the distorted layers 110A, 110B extend by a flow distance 114A, 114B respectively beyond the width W of the dried desired swathe 110 of FIG. 1B, so that the swathes 110A,110B have a width WA and WB respectively, where WA>W and WB>W.

It may be generally understood that the extent of any gravity-induced flow beyond the width W may vary along the swathe (e.g., in the z-direction) such that the flow distances 114A, 114B may vary in the z-direction. It may also generally be understood that the shape and thickness of the dried uncompensated swathes 110A, 110B may also vary in the z-direction such that the cross-section at any given z-position may be different, but similar to, those depicted schematically in FIG. 1C and FIG. 1D. However, it may be understood that the variation in shape, thickness, and flow extent may be within measurable or predictable ranges. It may be understood that such thickness variation may occur no matter the direction of printing, or the size of the printed area on the surface of the complex substrate 100 and that the extent of such flow, and hence the thickness variation, may depend on a number of factors, as described above, including the fluid composition, ambient conditions and the properties, including shape and orientation, of the complex substrate 100.

It was surprisingly realised that by adjusting the volumes and/or spatial resolution of fluid droplets that are ejected onto a substrate at different locations, it is possible to mitigate for flow-induced thickness variation and produce a more uniform print thickness, thereby reducing or overcoming the above-described disadvantages. For example, some droplet ejection heads are capable of printing using what is generally referred to as greyscale technology or ‘greyscaling’. This is the ability of certain droplet ejection heads to eject fluid droplets at a number of different volumes (e.g., by ejecting different droplet sizes (volumes), or alternatively by ejecting a number of smaller droplets, depending on the drop volume required, that form a single drop at a given location on the substrate). The droplets may coalesce in-air or on-substrate depending on a range of factors, including the droplet ejection head type; the fluid type, etc. The number of grey levels can be defined as the number of different droplet sizes, or volumes, that it is possible for a particular droplet ejection head to produce, (including what is referred to as ‘white’, where no droplet is ejected). For example, the Xaar 1002 GS6 printhead can produce seven different sizes of droplet on substrate between volumes of 6 and 42 picolitres. This means that the Xaar 1002 GS6 is capable of printing 8 grey levels (including ‘white’). Generally, greyscaling capability may be used for image control, e.g., to eject a range of droplet volumes in accordance with print instructions so as to refine the appearance of the edges of printed features, for example, or for graphics alignment. However, it was realized that greyscaling may also be used as a way to adjust the volumes of fluid that are ejected so as to mitigate for thickness variation due to on-substrate fluid flow, such as fluid flow due to the non-horizontal orientation of the substrate, or flow at swathe edges. Adjusting the ejected volumes may produce a more uniform print thickness, thereby reducing or overcoming the above-described disadvantages.

FIG. 1E and FIG. 1F depict schematic cross-sections through first and second compensated droplet arrays 105A, 105B. The compensated droplet arrays 105A, 105B respectively address the dried uncompensated swathes 110A,110B of FIG. 1C and FIG. 1D by selectively increasing or decreasing the volume of individual droplets in a respective array. For example, in FIG. 1E droplet 105Ai has an increased volume compared to the droplet 105i, and droplets 105Aiii-105Av have gradually decreasing volumes compared to the droplet volumes at the comparable positions of droplets 105i-105v of FIG. 1A, with droplet 105Av being “white” or non-ejection of a droplet. In FIG. 1F, droplet 105Bii has been increased in volume compared to droplet 105Bi and droplets 105Biii-105Bv gradually decrease in volume to non-ejection of a droplet at 105Bv, so as to produce a dried compensated swathe cross-section that is closer to the dried desired swathe 110 of FIG. 1B. It may be understood that FIG. 1E and FIG. 1F are merely representations of the concept that adjusting the droplet volume by increasing or decreasing the amount of fluid ejected from particular nozzle(s) can be used to counter the changes in thickness from the ideal or desired value or range of values Nt that is caused by on-substrate fluid flow effects.

In general, a method of ejecting droplets to compensate for variation in the thickness of an uncompensated swathe due to on-substrate fluid flow may comprise:
a. receiving uncompensated image data and a predefined nominal thickness Nt;
b. determining the thickness variation at one or more locations of the one or more dried uncompensated swathes 110A, 110B compared to the predefined nominal thickness Nt;
c. determining compensating image data to account for said thickness variation;
d. ejecting fluid volumes in the form of droplets of fluid through one or more nozzles of a droplet ejection head onto a substrate according to said compensating image data.

It may be generally understood that the uncompensated image data may comprise information regarding the image to be printed, it may further comprise geometric information for the substrate to be printed on, which may be a complex substrate 100, or the geometric information may be provided separately, as CAD data, or from a surface scan of the substrate to be printed on or a representative example.

It may be generally understood that at locations where there is no thickness variation the compensating image data for that location may comprise the uncompensated image data for that location and that therefore the droplet volume ejected at that location may be the uncompensated droplet volume for that location. It may further be understood that where the thickness at a given location is less than the predefined nominal thickness Nt, then the compensating image data for that location may comprise ejecting a droplet that is larger than the uncompensated droplet volume for that location and conversely where the thickness at a given location is greater than the predefined nominal thickness Nt then the compensating image data for that location may comprise ejecting a droplet that is smaller than the uncompensated droplet volume for that location.

It may further be understood that the thickness variation may be determined at a representative range of points on the uncompensated swathe, rather than at every point where a droplet is to be deposited. The determination of the compensating image data to account for said thickness variation may therefore comprise an interpolation method, or other suitable calculation, to determine droplet volume compensations for all points where a droplet is to be ejected, based on the thickness variation at the representative range of points on the uncompensated swathe or layer. Alternatively, the thickness variation may be determined at a resolution higher than the droplet resolution to determine how the fluid has moved between droplet points, with an interpolation regime from this higher resolution thickness data being used to determine the compensating image data.

It may be generally understood that thickness variation may be determined in a number of ways, for example by creating one or more test substrates by ejecting a test pattern of droplets from a droplet ejection head onto one or more test substrates 100 and allowing the fluid to dry. The test pattern of droplets may, for example, produce an image of a square formed by a number of droplets of known droplet volumes. Alternatively, the test pattern of droplets may be that generally required to form the desired image on a flat horizontal surface, e.g., the image that would be produced using the uncompensated pattern of droplets if the substrate were horizontal and not a complex substrate and not subject to on-substrate fluid flow.

It may be generally understood that the droplet volumes to produce the test pattern may all be the same droplet volume, or they may vary depending on what is required to produce the desired image (for example the desired image may already have variation in droplet volumes to refine image edges, for example, as is generally known in the art). It may be understood that the test substrates may have the same or similar shape and geometric orientation as that of the desired substrate, or they may be representative of a range of shapes and orientations. For example, for printing onto inclined surfaces a range of test substrates inclined at a range of angles β to the horizontal from 0° to 90° may be used.

It may generally be understood that once the test substrate(s) have been produced and the droplets have dried, that the thickness variation from the predefined nominal thickness Nt (e.g., the desired thickness of the swathe or layer) may be determined at a representative range of points on the one or more test substrates. The thickness variation may be determined by measurement, for example using surface probes, profilometer, interferometry, laser scanners or any other suitable method to measure the thickness variation and/or the surface topography at one or more locations on the test substrate and or the desired substrate. It may generally be understood that if a range of test substrates have been used, the thickness variation on a desired substrate may be determined by interpolation from the test substrates (for example if the desired substrate is angled at 45° to the horizontal, and there are test substrates oriented at 40° and 50° to the horizontal, then an interpolation routine may be used to determine the thickness variation on the desired substrate).

Alternatively, rather than printing test substrates for every desired substrate and application, the thickness variation may be determined using a lookup table; or by using mathematical models and calculations. The lookup table and/or the calculations may be based on a range of parameters such as fluid type, ambient conditions, properties of the complex substrate, etc. Where the thickness variation is determined using a lookup table, this may have been populated using data from a plurality of test substrates, for example, or by using mathematical models and predictions. In producing data for a lookup table from a plurality of test substrates, it may be understood that this may be done for the desired fluid, or for a range of test fluids with a representative range of properties. The test fluids, for example, may be for a range of viscosities and/or particle loadings and/or particle sizes, and/or carrier fluid types and/or carrier fluid % volumes, and/or temperatures, etc.

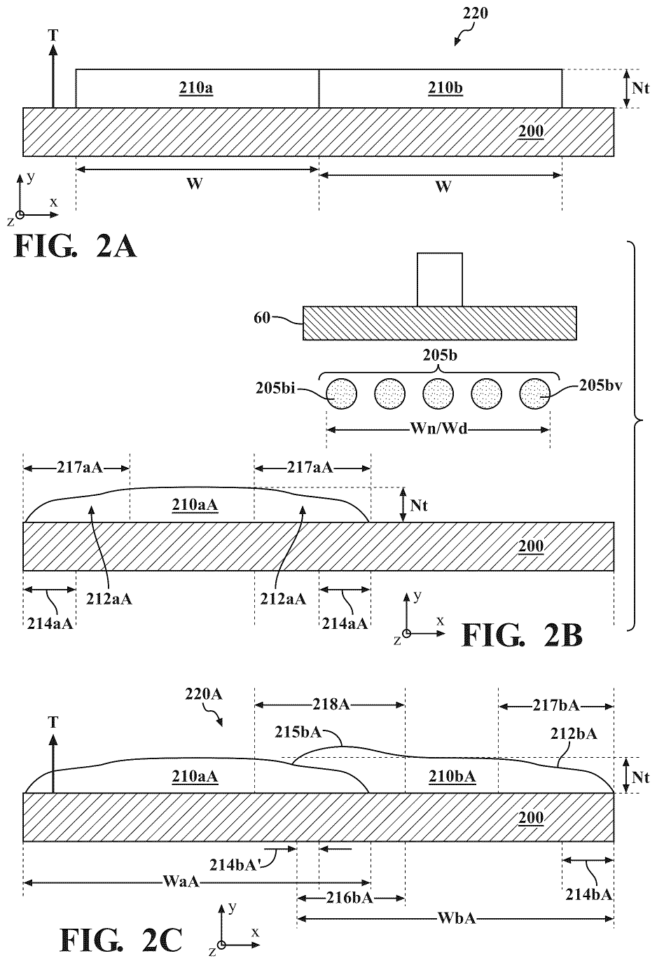

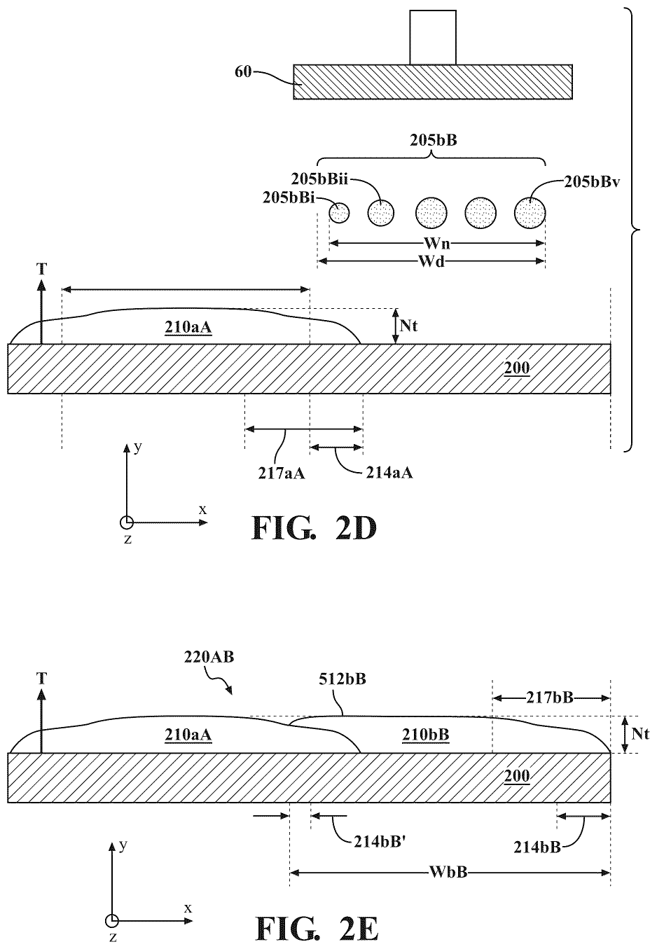

Turning now to FIG. 2A-FIG. 2E, these depict fluid flow at swathe edges. For simplicity this is depicted on a flat horizontal substrate 200, but it may be understood that such flow may also occur on non-flat, non-horizontal complex substrates. FIG. 2A depicts a schematic cross-section through two dried desired swathes 210a,210b arranged adjacent to each other on a horizontal substrate 200 and having a thickness Nt.

FIG. 2B depicts a schematic cross-section through a first dried uncompensated swathe 210aA arranged on the horizontal substrate 200 of FIG. 2A and an uncompensated array of droplets 205b that have been ejected from a droplet ejection head 60 to produce a second swathe. The droplets 205bi-205bv are all the same volume, but it may be understood that this is by no means essential, depending on the requirements of the application. It can be seen that prior to drying fluid has flowed outward in the x-direction at either side of the first dried uncompensated swathe 210aA such that the width WaA of the dried uncompensated swathe 210aA is greater than the width W of the dried desired swathe 210a. The outward flow at either side has a width 214aA. It can also be seen that the first dried uncompensated swathe 210aA also comprises a region of thinner swathe 212aA having a thickness less than the predefined nominal thickness Nt and a width 217aA. The thinner region 212aA has a greater extent in the x-direction than the outward flow such that width 217aA>width 214aA, which means that the thinner region 212aA starts within the width W of the dried desired swathe 210a.

FIG. 2C depicts a schematic cross-section through the first dried uncompensated swathe 210aA and a second dried uncompensated swathe 210bA that is arranged adjacent to the first, e.g., after the array of droplets 205b of FIG. 2B have landed on the substrate 200 and formed a second dried uncompensated swathe 210bA adjacent to the first dried uncompensated swathe 210aA on the horizontal substrate 200 of FIG. 2A. It can be seen that on the left-hand side of the second dried uncompensated swathe 210bA there is an overlying portion 215bA of width 216bA where the combined swathe thickness in that portion is greater than the predefined nominal thickness Nt. It can be seen that the right-hand side of the second dried uncompensated swathe 210bA is similar to the right-hand side of the first dried uncompensated swathe 210aA with a region of thinner swathe 212bA having a width 217bA and extending beyond the desired swathe width W by 214bA.

FIG. 2D depicts a compensated droplet array 205bB ejected from droplet ejection head 60 to address the second dried uncompensated swathe 210bA of FIG. 2C and FIG. 2E depicts the second dried compensated swathe 210bB produced by the compensated droplet array 205bB. It can be seen that part of the second dried compensated swathe 210bB overlies the first dried uncompensated swathe 210aA of FIG. 2B, but that the reduced volume of droplets 205bi and 205bii has reduced the volume in the region of the overlying portion 215bB such that the combined swathe thickness is Nt. It may be generally understood that FIG. 2D-FIG. 2E depict an example of a way to address the thickness variation at the swathe join between adjacent swathes 210 whereby the volume of fluid ejected in the subsequent swathe (in the example 210b) is decreased in a region adjacent to the swathe join. Alternatively, the volume of fluid ejected adjacent to the swathe join could be decreased in the initial swathe (i.e., in 210a) or the volume could be decreased in both the initial and subsequent swathe (210a and 210b) so as to control the thickness adjacent to the swathe join. Compensating for the thickness variation may comprise adjusting the volume of fluid to be ejected at a given location (e.g., by adjusting on a per-pixel (e.g., per-droplet) basis based on measured thickness data for the pixel location. Such adjustments may comprise increasing or decreasing the volume of fluid to be ejected at a given location, for example on a per-pixel basis. Alternatively, the volume adjustments may be by interpolation between the one or more locations on the uncompensated layer where the thickness variation was determined.

Alternatively, a correction region may be defined by determining the boundaries or edges of a region over which the thickness varies, for example thickness variation region 218A in FIG. 2C which extends to either side of the desired swathe join location. Alternatively, the correction region may be wider than the thickness variation region 218A by a percentage to either side, so as to enable greater smoothing of the swathe join, for example 0-20% or 0-10% wider than the thickness variation region 218A. The compensating image data in the correction region may comprise gradually altering the volume of fluid ejected over the correction region using an algorithm.

It may be generally understood that where the correction region covers two adjacent swathes, the volume of fluid ejected in the correction region may be altered in the initial swathe, the subsequent swathe, or in both. For example, compensating image data may comprise adjusting the printing volume so that half of the desired volume is ejected over a portion of the initial swathe adjacent to the swathe edge (in the correction region) and half of the desired volume may be ejected over a portion of the subsequent swathe adjacent to the swathe edge join (in the correction region). Alternatively, the compensating image data may comprise tapering the drop size between adjacent swathes over a portion of the swathes adjacent to the join, e.g., over the correction region, for example using grey-scaling. Other algorithms may be used to adjust the droplets being ejected, for example, pattern-based volume alterations such as dithering, half-tone-screening, gradients, etc. may be applied to the image data. Still further, a combination of methods may be used, for example a gradient of drop sizes in part of the correction region, and then a dither pattern in another part. It may also be the case that different methods may be used at different stages in an iterative process, for example, an initial guess may use one technique, with alternative methods being used in subsequent refinement steps of determining the compensating image data.

It may further be generally understood that determining the compensating image data to compensate for thickness variation may comprise altering the spatial resolution of the droplets being ejected (e.g., ejecting fewer/more droplets over a given area to alter the droplet density, for example, by using the non-firing or “white” droplets to reduce the on-substrate droplet density) and/or the volume of the droplets being ejected may be altered. Simple methods such as tapering the number of droplets ejected may be utilised, or more complex algorithms as described above may be used to alter the spatial resolution. Still further, it may be understood that altering the volume of droplets may comprise increasing and/or decreasing the volume of droplets ejected on a per-droplet basis. Likewise, altering the spatial resolution may comprise increasing or decreasing the droplet density.

It may be generally understood that determining compensating image data to compensate for thickness variation may generally comprise determining the location of swathe joins and/or the orientation and/or curvature and/or other geometric features of a complex substrate so as to determine where the thickness variation occurs. This may be done using measuring techniques, or by using the image data, for example CAD data, the swathe width (depending on chosen droplet ejection head) and the desired droplet ejection head path, for example.

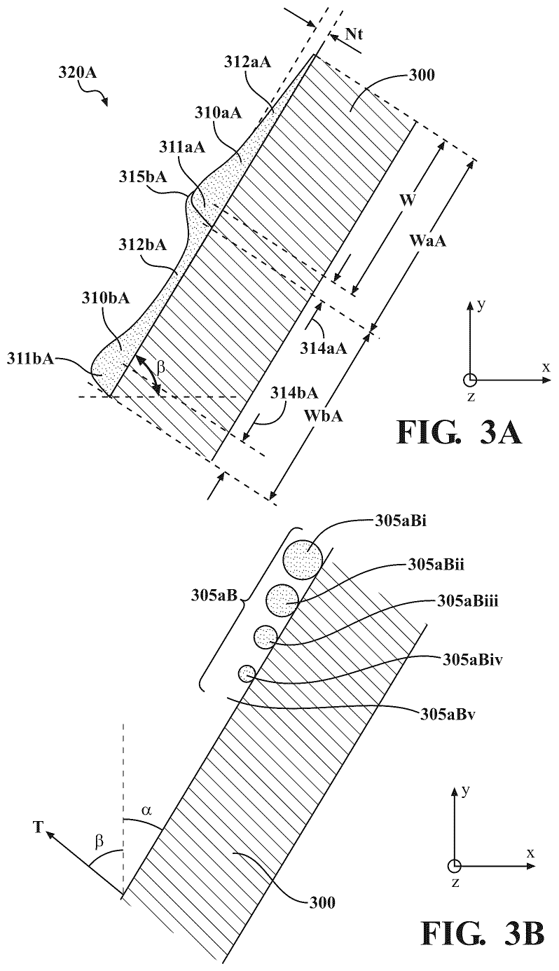

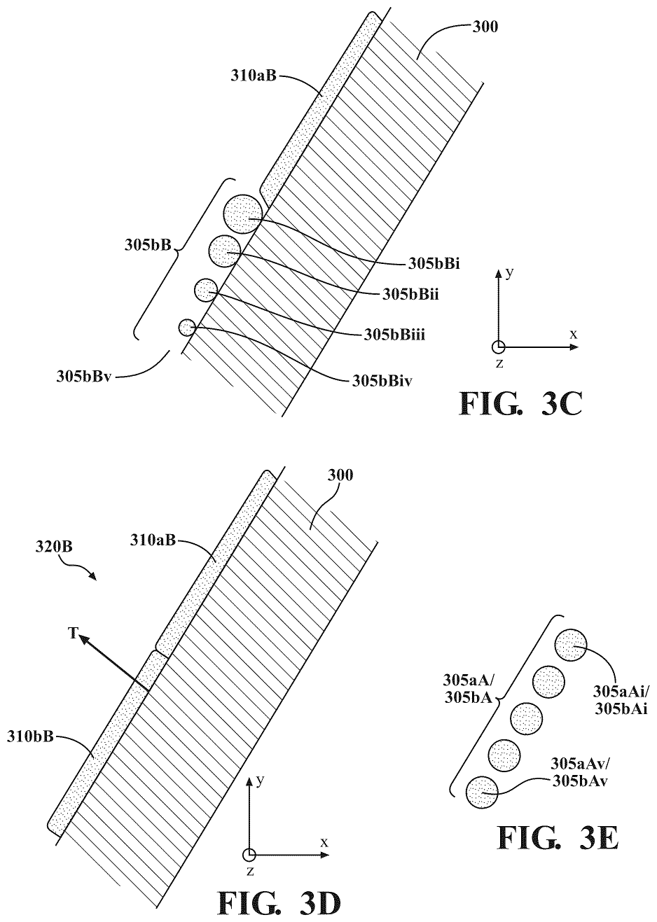

Turning now to FIG. 3A to FIG. 3E, these depict a non-horizontal complex substrate 300, similar to that of FIG. 1A, at several stages as two adjacent swathes are deposited on the substrate 300. FIG. 3A depicts a schematic cross-section through first and second dried uncompensated swathes 310aA,310bA arranged on the complex substrate 300. These may have been formed using an uncompensated array of droplets 305aA,305bA as depicted in FIG. 3E, similar to uncompensated array of droplets 105 of FIG. 1A. FIG. 3B depicts a schematic cross-section through a first compensated array of droplets 305aB on the complex substrate 300, similar to that of FIG. 1E, where 305aBi is larger than 305aBii and 305aBiii-305aBv are smaller, with 305aBv being a non-firing or “white” droplet. FIG. 3C depicts a schematic cross-section through the first dried compensated swathe 310aB formed from the first compensated array of droplets 305aB and a second compensated array of droplets 305bB, both arranged on the complex substrate 300. It can be seen that the first and second compensated arrays of droplets 305aB,305bB are similar, though it may be understood that this is by no means essential and in other arrangements, depending on the shape of the dried uncompensated swathes 310aA,310bA, the two arrays of droplets may differ so as to correct for their respective dried uncompensated swathe. Turning now to FIG. 3D, this depicts a schematic cross-section through the first and second dried compensated swathes 310aB,310bB of FIG. 3C on the complex substrate 300. It can be seen that adjusting the volumes of the droplets ejected has improved the shape of the swathes 310a,310b as compared to FIG. 3A.

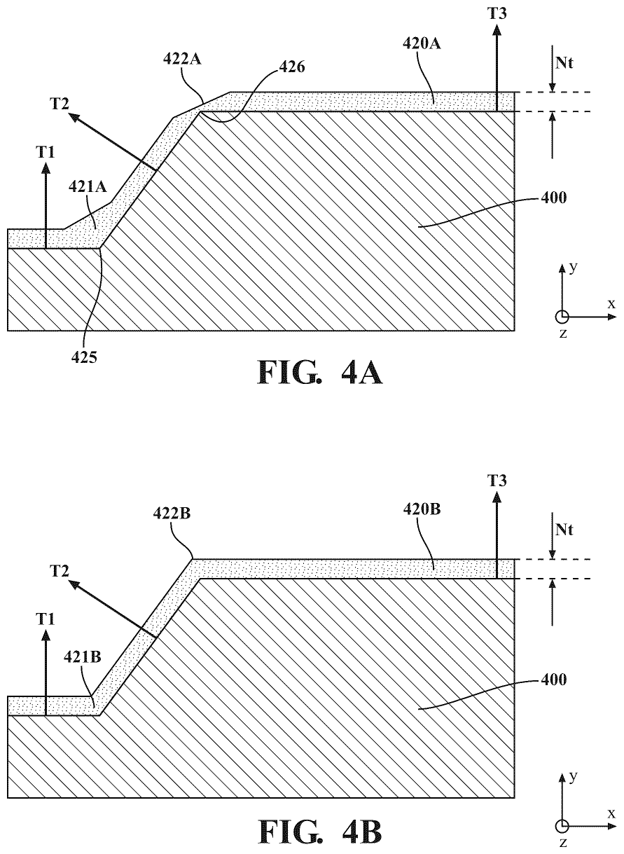

FIG. 4A depicts a schematic cross-section through a distorted dried layer 420A on a multiple-surface complex substrate 400. It can be seen that the thickness direction T varies in orientation such that it remains perpendicular to the surface of the complex substrate 400. The layer 420A may comprise one or more swathes. It can be seen that there is an accumulation of material 421A in the internal corner 425 and a thinning of material 422A in the external corner 426 of the complex substrate 400. FIG. 4B depicts a schematic cross-section through a corrected dried layer 420B on the complex substrate 400 of FIG. 4A. The print instructions for coating the complex substrate 400 may have been adjusted to decrease the fluid deposited at the internal corner 425 and to increase the fluid deposited at the external corner 426 so as to correct for the defects and provide a more uniform dried layer 420B with corrected regions 421B, 422B.

It may be generally understood that there may be a plurality of swathes in a layer on a complex substrate such as complex substrate 400, and that subsequent swathes arranged adjacent to previous swathes may be corrected in a similar manner to that depicted in FIG. 3C, and FIG. 3D and that depicted in FIG. 2D and FIG. 2E, depending on the orientation of the substrate in a given region.

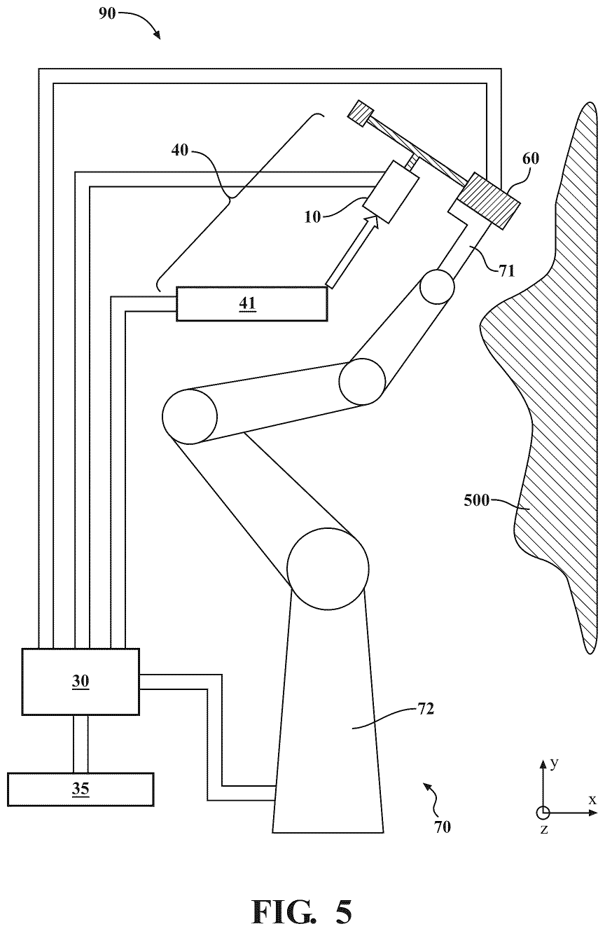

Turning now to FIG. 5, this depicts a droplet ejection apparatus 90 addressing a complex substrate 500, wherein the droplet ejection apparatus 90 comprises a fluid supply system 40, a movement device 70 and a droplet ejection head 60 connected to the fluid supply system 40 and mounted on the movement device 70. It may be understood that this is not limiting and there may be one or more droplet ejection heads 60 and one or more movement devices 70, depending on the application. The fluid supply 40 may be a one or more fluid supplies, depending on the requirements of the application. There is also a processor 35 and a controller 30. The controller 30 is controlled by the processor 35 and is configured to control the printing process. The controller may control the fluid supply system 40, the movement device 70 and the droplet ejection head(s) 60 in accordance with a printing strategy from the processor 35. The printing strategy may comprise topographical information concerning the complex substrate 500 and the positional relationship between the movement device 70, the droplet ejection head(s) 60 and the complex substrate 500, image data regarding what is to be printed on the complex substrate 500 and movement data concerning how the complex substrate is to be addressed (where and in what order print swathes are to be applied). The printing strategy may further comprise controlling the fluid pressure in the droplet ejection head(s) 60 using one or more control devices 10 so as to ensure that the droplet ejection head(s) do not weep or ingest air in response to induced pressure changes as they are moved.

For simplicity the fluid supply system 40 is depicted in simplified form with an arrow indicating the fluid supply path. There is a fluid reservoir 41 and a control device 10 located adjacent to the droplet ejection head 60. In this arrangement, the movement device 70 is shown schematically as a robotic arm 72 where the droplet deposition head 60 is arranged on a mount 71 on a robotic arm 72 and is shown addressing a 3D body 500. It can be seen that the use of the robotic arm 72 allows the droplet ejection head to address the bumps and contours on the surface or non-planar surfaces of the 3D body 500. Thus, the apparatus 90 comprises a movement device 70 configured to be movable in three or more directions and/or orientations, further, the movement device 70 is a robotic arm 72 with a plurality of degrees of freedom. Depending on the requirements of the application, it may be generally understood that there may be one or more movement devices 70 and/or one or more robotic arms 72. It may further be generally understood that the movement device 70 may be any suitable device or mechanism with a plurality of degrees of freedom. It may be understood that according to the requirements of a particular implementation a fluid supply system 40 may comprise one or more control devices 10 located at one or more predetermined locations in order to control the fluid supply pressure adjacent to the one or more droplet ejection heads 60 so as to maintain the print performance and droplet size as required. The control devices 10 may be in communication with a controller 30. It may be generally understood that the one or more droplet ejection heads may be recirculating droplet ejection heads, in which case the fluid supply system 40 may supply fluid to the droplet ejection heads and remove un-ejected fluid from the droplet ejection heads and the control devices 10 may be suitable to control the inflow and/or the outflow to and from the droplet ejection heads. The fluid supply system 40 and/or the control devices 10 may be arranged to control the fluid pressure and/or the recirculation flow rate.

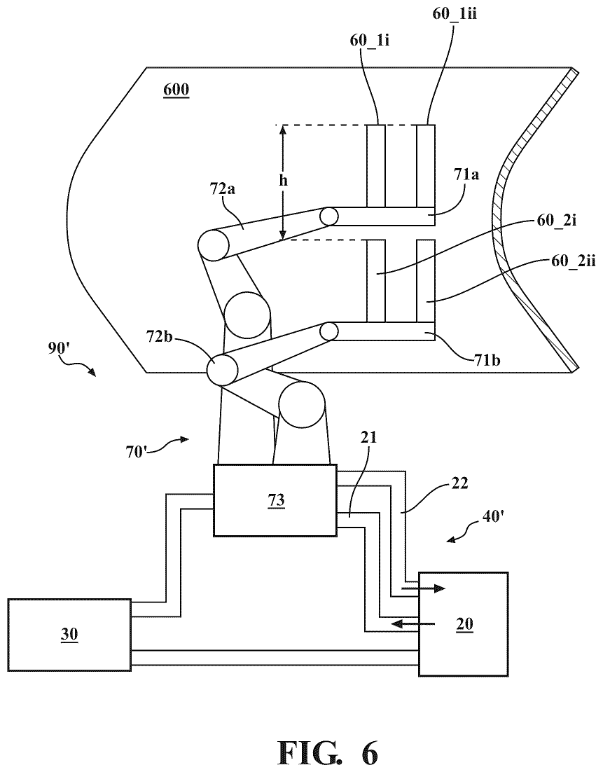

FIG. 6 is a schematic representation of a multi-axis, multi-arm droplet ejection apparatus 90′ comprising a plurality of droplet ejection heads 60_1i-60_2ii mounted on a movement device 70′ to address a convex complex substrate 600. The movement device 70′ comprises two arms 72a, 72b connected to a common base 73. The arms 72a, 72b may be movable independently of each other. Additionally, the base 73 may also be moveable depending on the requirements of the particular application. Each of the arms 72a, 72b has two droplet ejection heads 60 mounted on mounts 71a, 71b. It may be understood that this is by no means limiting and an apparatus 70′ may comprise one or more arms 72a, 72b and/or one or more droplet ejection heads 60 and that each arm 72a, 72b may comprise one or more mounts 71a, 71b for one or more droplet ejection heads 60 to be mounted therein.

The droplet ejection apparatus 90′ further comprises a fluid supply system 40′. The fluid supply system 40′ comprises a fluid supply 20 and fluid paths 21,22 which may supply fluid to the droplet ejection heads 60 and remove un-ejected fluid from the droplet ejection heads 60 respectively (for simplicity the entirety of the fluid paths 21,22 are not depicted). In some applications there may be no fluid return path 22, i.e., all of the fluid supplied to the droplet ejection heads 60 may be ejected from the droplet ejection heads 60 during normal operation. However, it may also be understood that the droplet ejection head(s) 60 may comprise a flow circulation design where a portion of the fluid is ejected via the one or more nozzles of the droplet ejection heads 60 and the remaining un-ejected fluid returns to the fluid supply 20 or to a collection reservoir (not shown).

The droplet ejection apparatus 90′ may additionally comprise a controller 30 or may be connected to an external controller 30 and/or to a processor 35. The controller 30 may control the movement apparatus 70′, and/or the fluid supply system 40′ and/or the droplet ejection heads 60_1i-60_2ii. Alternatively, the processor 35 may comprise some or all of the functionality of the controller 30 to control parts or all of the droplet ejection apparatus 90,90′. The controller 30 and/or the processor 35 may comprise or be provided with a lookup table to enable determination of thickness variation due to on-substrate fluid flow. Alternatively, one or other of the controller 30 and/or the processor 35 may be provided with suitable programming and/or algorithms to predict thickness variation due to on-substrate fluid flow.

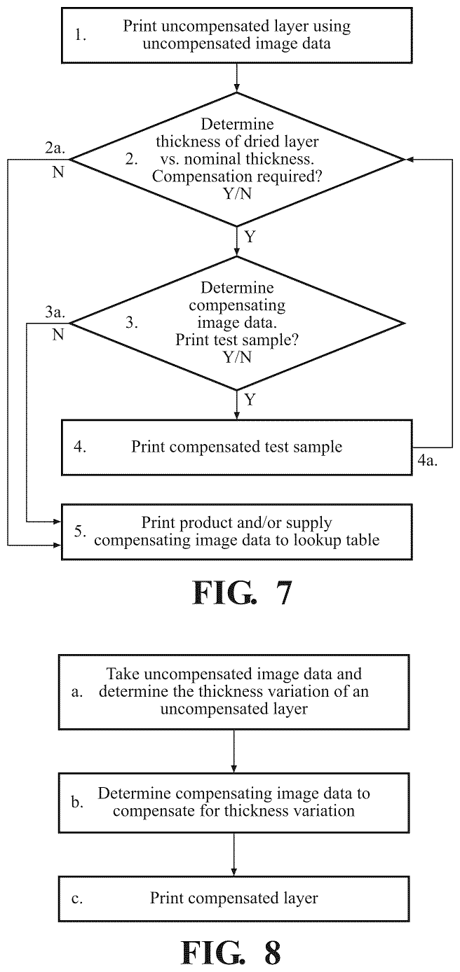

Turning now to FIG. 7, this is a diagram of the method steps to measure and compensate for thickness variation due to on-substrate fluid flow, which may be enacted by the droplet ejection apparatus 90,90′ or any other suitable apparatus, the method comprising the following steps:
1. Use the uncompensated image data to print an uncompensated layer;
2. Determine the thickness of the dried layer vs the nominal thickness and determine whether compensation is required;
2a. If compensation is not required, proceed to step 5;
3. If compensation is required, determine the compensating image data and determine whether or not to print a compensated test sample;
3a. If test sample is not required, proceed to step 5;
4. Print the compensated test sample;
4a. Return to step 2 and repeat steps 2-4 as necessary;
5. Print the product and/or supply compensating image data to a lookup table.

It may be generally understood that the uncompensated layer in step 1 may comprise a single swathe, or a plurality of swathes. Additionally, the uncompensated layer and subsequent compensated layers may be printed onto suitable test substrates and/or instances of the desired substrate. Further, for providing data to a lookup table, or to generate application-specific data, a plurality of uncompensated layers and compensated layers may be printed on a plurality of test substrates and/or the desired substrate using the desired fluid and/or one or more suitable test fluids and repeating the above steps. Still further, steps 2 to 4a may repeated one or more times in an iterative loop until final compensating image data is determined, for example an initial best guess at the compensating image data on the first path through steps 2 to 4a may be followed by one or more repeat loops, for example fine-tuning loops comprising printing further adjusted compensating image data onto one or more test substrates and/or instances of the desired substrate.

The plurality of test substrates may be a range of test substrates sufficient to characterize the on-substrate fluid flow, measure it and determine compensating image data. For example, as described above, the test substrates may comprise the same test substrate, such as a flat plate, at one or more angles of inclination to the horizontal. Additionally, or instead one or more differently shaped complex substrates at one or more angles of inclination may be used as test substrates, for example a range of curved surfaces with different angles of curvature, arranged at different angles of orientation, or cylinders with a range of different radii, or flat plates with bends at a range of angles, etc. may be used as test substrates. Additionally, or instead, a range of layer thicknesses Nt and a number of differently oriented swathe joins, etc. may be tested, as appropriate, so as to populate an application-specific lookup table and/or populate a more general lookup table. In some applications application-specific test substrates may be used, such as a range of cross-sections of the desired product, for example, or component parts of the desired product.

FIG. 8 is a diagram of the method steps to determine and compensate for thickness variation due to on-substrate fluid flow of a dried uncompensated layer and print onto a substrate, said method comprising:
a. receiving uncompensated image data and a predefined nominal thickness Nt;
b. determining the thickness variation from the predefined nominal thickness Nt at one or more locations on a substrate of one or more dried uncompensated layers;
c. determining compensating image data to compensate for the thickness variation;
d. ejecting droplets of fluid through one or more nozzles of a droplet ejection head using said compensating image data to form a dried compensated layer on said substrate.

It may be generally understood that determining the thickness variation may comprise:
i. ejecting droplets of fluid through one or more nozzles of a droplet ejection head using uncompensated image data to form one or more dried uncompensated layers on one or more substrates;
ii. determining the thickness variation from the predefined nominal thickness Nt of said one or more dried uncompensated layers at one or more locations on said one or more dried uncompensated layers.

Depending on the application the one or more substrates may be one or more test substrates as described above, or one or more instances of the desired substrate and the fluid may comprise the desired fluid or one or more test fluids, or a range of test fluids. Having printed one or more uncompensated layers (which may comprise one or more swathes, similarly the compensated layers may comprise one or more swathes) in accordance with the uncompensated image data the method may comprise determining the thickness variation by measuring the thickness and/or surface topography of said one or more dried uncompensated layers at one or more locations on said one or more dried uncompensated layers.

Instead of printing onto one or more substrates or test substrates, the method may comprise in step b. determining the thickness variation using a lookup table populated with data, as described above. Still further, the step b. of determining the thickness variation may comprise calculating the thickness of the one or more dried uncompensated layers at one or more locations using mathematical models.

Similarly, step c. of determining the compensating image data may comprise using a mathematical method. For example, mathematical models and/or empirical models may be used to calculate the thickness variation and/or to determine the compensating image data. Alternatively, step c. may comprise using a lookup table to determine the compensating image data.

Step c. of determining compensating image data to compensate for thickness variation may comprise adjusting the volume of fluid to be ejected at a given location (e.g., by adjusting on a per-pixel basis based on measured thickness data for the location of the pixel. As previously discussed, such adjustments may comprise increasing or decreasing the volume of fluid to be ejected at a given location, for example on a per-pixel basis, or by interpolation between the one or more locations on the uncompensated layer where the thickness variation was determined. Alternatively, a correction region may be defined adjacent to the swathe edge(s), over which the volume of fluid ejected is gradually altered based on an algorithm. It may be generally understood that such a correction region may be the varying thickness region 218A between two adjacent swathes as seen in FIG. 2C or it may be one or more regions of varying thickness where fluid has flowed on a substrate due to its angle of inclination to the horizontal, as seen in FIG. 1C and FIG. 1D or it may be both, as seen in FIG. 3A. In general, there may be one or more such correction regions in a layer, depending on the desired image, the image size, etc. As previously discussed, the correction region may be wider than the varying thickness region by a percentage to either side, so as to enable greater smoothing of the swathe join, for example 0-20% or 0-10% wider than the region 218 of altered thickness. Alternatively, the correction region may be narrower than the varying thickness region, if for example Nt is a range and some of the varying thickness region is still within acceptable tolerances. Still further, the swathe positions may be adjusted, for example moving or adjusting the droplet ejection path such that there is a “gap” between the desired dried swathe locations 210a,210b which in the compensated swathes would be filled by on-substrate fluid flow, but which might reduce the overflow between swathes.

It may be generally understood that the flow behavior and/or drying time of the fluid may be affected by the fluid properties and composition, such as viscosity, temperature, type(s) of constituent fluids present (types of solvent(s) used, for example), plasticizers, particle loading, particle size, particle size distribution, particle shape, density, etc., as described in further detail below. As previously described some fluids may undergo loss of volume when drying (for example due to evaporation of carrier fluids) others may undergo chemical changes that lead to contraction of the volume of the coating as the fluid dries or cures (for example chemical bonding, such as polymerization, cross-linking, etc.).

The flow behavior and drying time may also be affected by environmental factors such as ambient temperature, humidity, etc. and by the thickness of the layer. The thickness of the layer on the substrate may be affected by the volume of fluid ejected from the nozzle(s) in the droplet ejection head, the nozzle spacing, the nozzle ejection frequency and the relative speed between the droplet ejection head and the substrate. The properties of the substrate, such as surface roughness, temperature, polarity, absorptive ability, chemical composition, porosity and any surface treatments on the substrate may also affect the drying time and the speed of the flow (and hence the spreading of the fluid on-substrate) beyond the expected width W of the swathe. Such above-described properties may influence the advancing contact angle and receding contact angle of the fluid on the substrate as the fluid flows upon it, and hence the shape and form of the final dried coating on the substrate.

As mentioned above, it may be generally understood that the term dried as used herein, for example “dried swathe” or “dried layer” may encompass any processes where a liquid, such as an ink or varnish or paint or other fluid-at-time-of-deposition liquid may be deposited on a substrate and undergo a process to form a desired non-liquid layer or coating on the substrate (e.g. a surface treatment or coating or decorative layer, or textural treatment, etc.). Such processes may include drying by evaporative loss of fluid, by curing, by chemical bonding once deposited on the substrate, etc.

It may further be understood that the non-liquid layer or coating on the substrate may undergo more than one process to form said non-liquid layer or coating on the substrate. For example, the liquid may be deposited and then lose volume (dry) by evaporative loss, for example, to form an intermediate layer, which may be a semi-solid layer, (for example, a “tacky” paint coating). The intermediate layer may undergo a subsequent process, such as a curing process (e.g., by heating in a controlled environment, or by irradiation with ultra-violet light) so as to form the final desired non-liquid layer or coating. It may further be understood that where there is an intermediate layer and a final desired non-liquid layer or coating, the thickness may be determined at either and/or both stages in order to determine whether the layer requires compensation as described herein.

It may generally be understood that, as previously discussed, on-substrate fluid flow may occur on non-complex (i.e., flat horizontal) substrates such as that of FIG. 2A-FIG. 2C, which may have on-substrate fluid flow at swathe edges and swathe joins. Complex substrates may have on-substrate fluid flow at swathe edges and swathe joins and may also have on-substrate fluid flow due to the orientation of part or all of the complex substrate to the horizontal.

It may generally be understood that complex substrate as used herein encompasses a substrate comprising one or more non-horizontal surfaces. For example, it may comprise one or more of vertical, sloping (e.g., inclined at an angle to the horizontal) and any other non-horizontal surfaces. The complex substrate may comprise one or more flat and/or one or more non-planar surfaces, for example one or more curved surfaces. The complex substrate may further comprise one or more horizontal surfaces (see for example Fig. FIG. 4A-FIG. 4B). Non-limiting examples of complex substrates may include walls and roofs of buildings, bottles and containers, vehicles, household items, consumer goods, etc. Such complex substrates may require application of one or more surface layers for a number of reasons, which may include aesthetic reasons, such as decoration or ornamentation, and/or for technical reasons such as protective coatings to prevent rust, erosion, water ingress, electrical or chemical insulation, etc., and/or for conveying information such as for advertising, labelling, barcodes, safety, tactile information provision, etc.).

It may generally be understood that the term desired substrate as used herein comprises the substrate that is of interest for a particular application, and may comprise a non-complex substrate, or it may comprise a complex substrate as described herein. For example the particular application may be printing onto a complex substrate such as a vehicle, for example a car, or part of a vehicle, for example a car door. It may also be generally understood that the desired fluid may be the fluid that is desired for a particular application, such as a paint or protective coating, for example.

The substrate may itself be coated, i.e., comprising one or more layers onto which the fluid may be applied. These one or more layers may be applied via the method, via conventional methods known in the art, or combinations thereof. Depending on the application, such layers may have specific names and/or functions, typically determined based on the components used to prepare such layers and/or the function of the layer itself. Examples of such layers, or coatings, include primers, basecoats, clearcoats, topcoats, midcoats, electrocoats, colorcoats, etc.

The term “basecoat” refers to a coating that is opaque and provides for protection, color, hiding (also known as “opacity”) and visual appearance. A basecoat typically contains color pigments, effect pigments such as metallic flakes pigments, UV absorbers, and other coating additives. The term “basecoat coating composition” refers to a coating composition that can be used to form a basecoat. Likewise, the term “basecoat layer” refers to a coating layer formed from such a basecoat coating composition. A basecoat layer can be formed by applying one or more layers of the same or different basecoat coating compositions. In automotive coatings, a substrate is typically coated with a primer layer for protection and adhesion, then a basecoat layer over the primer layer, optionally a sealer on top of primer, for most of protection, color and most of visual appearance, and subsequently a clearcoat layer over the basecoat layer for further protection and visual appearance. Sometimes, a single coating layer, referred to as “top coat” can be used to provide the function of both the basecoat and the clearcoat. Additional coating layer can also be used. For example, a metal substrate can be treated with a phosphate material and coated with an electrocoat layer before applying the primer layer.

The term “mid coat” or “mid coat layer” refers to a colored non-opaque coating positioned between a basecoat layer and a clearcoat layer in a multi-layer coating system. To achieve some unique and attractive colors or visual effects, the automobile industry and other coating end use applications can use multi-layer coatings having three or more coating layers instead of the traditional “basecoat and clearcoat” two-layer coating system. The multi-layer system can usually comprise at least a first colored and opaque basecoat layer, a second non-opaque color coat deposited over at least a portion of the basecoat layer, and a third clearcoat layer deposited over at least a portion of the second non-opaque color coating layer. The second non-opaque color coat is typically referred to as a mid coat layer, which contains colored pigments. The mid coat is typically formulated to be non-opaque so the color of the basecoat underneath can be visible through the mid coat.

Prior layers, e.g. the first basecoat layer may be applied to the substrate utilizing a conventional spraying apparatus, such as a Bell applicator, and then subsequent layers, e.g. the second basecoat layer may then be applied to the first basecoat layer utilizing the high transfer efficiency applicator. One or more considerations can be used in this, such as considering the impact of the surface tension of the first basecoat layer on the second basecoat layer. For example, the surface tension of the first basecoat layer may be increased to improve flow of the coating composition as being applied to the first basecoat layer utilizing the high transfer efficiency applicator. This improved flow may be desirable when printing the coating composition on a full panel of a vehicle. Similarly, the surface tension of the first basecoat layer may be decreased to improve improved boundary retention and/or resolution of the coating composition as being applied to the first basecoat layer utilizing the high transfer efficiency applicator. This improved boundary retention and/or resolution may be desirable when printing the coating composition as a design, a writing, and the like. Further, one may consider the impact of wet-on-wet application between the first basecoat layer and the second basecoat layer. For example, carrier selection and additive selection may have an effect on the suitability for the coating composition to be applied to the first basecoat as a wet-on-wet application.

It may be generally understood that the method herein may be used to replace and/or supplement any traditionally-applied layers, e.g. via substitution, addition of new layers between existing layers, or adding an extra layer on top of existing layers. Examples of such multi-layer applications are outlined in the tables below:

### Multi-Layer Example 1—Wet Process

| Layer | Traditional Application | Present Embodiments |
|---|---|---|
| Primer | Spray | Spray |
| BC | Spray | Overspray free |
| CC | Spray | Spray |

### Multi-Layer Example 2—Wet Process

| Layer | Traditional Application | Present Embodiments |
|---|---|---|
| Primer | Spray | Spray |
| BC - color 1 | Spray | Spray |
| BC - color 2 | Mask, spray, de-mask | Overspray free |
| CC | Spray | Spray |

### Multi-layer Example 3—Topcoat

| Layer | Traditional Application | Present Embodiments |
|---|---|---|
| Primer | Spray | Spray |
| BC - color 1 | Spray | Spray |
| CC | Spray | Spray |
| Monocoat - color | Mask, spray, demask | Overspray free |
| 2 | | |

### Multi-layer Example 4—Topcoat

| Layer | Traditional Application | Present Embodiments |
|---|---|---|
| Primer | Spray | Spray |
| BC - color 1 | Spray | Spray |
| CC | Spray | Spray |
| BC - color 2 | Mask, spray, demask | Overspray free |
| CC | Spray | Spray |

It may be generally understood that the predefined nominal thickness Nt of the layer on the substrate may not be a single value, but may comprise an acceptable range within which the thickness of a layer should lie Nmin<Nt<Nmax. The minimum Nmin and the maximum Nmax may be set by aesthetic or practical considerations. For example, an acceptable minimum thickness may be that required to prevent corrosion, or to provide a visually uniform surface cover, or that required for durability and scratch resistance. An acceptable maximum thickness may be that in which drying of the layer occurs in a suitable time-frame prior to subsequent steps in a production process, for example, or to maintain an item within an allowable weight range. In some applications the predefined nominal thickness Nt may be a predefined nominal thickness profile, for example a gradual variation of the nominal thickness along the layer (as opposed to step changes) may be of more importance, i.e., it isn't one thickness or thickness range that is of interest, but the continuity and smoothness along the surface and hence the predefined nominal thickness may comprise an allowable rate of change of thickness with distance rather than or as well as an absolute thickness value.

It may further be understood that depending on the print application and desired end result, different predefined nominal thicknesses Nt may be acceptable at different locations, for example. For instance, a surface feature or ornamentation may be designed to have a thickness variation across the feature, with different nominal thicknesses Nt(x,y,z) at different points. It may also be understood that where a swathe join lies within such a feature, the nominal thickness(es) Nt across the join may be controlled using the methods of the present embodiments to fall within acceptable nominal thicknesses Nt(x,y,z) at and adjacent to the location(s) of the swathe join.

Still further, it may be understood that in some applications the predefined nominal thickness Nt may not be provided as a separate value or range, but may be determined from the uncompensated image data by classing the number of droplets in a given area as being directly related to the intended thickness. For example, 25 g of desired fluid deposited over an area of 1 m² would lead to a desired layer on the surface of 25 g/m², from which an expected predefined nominal thickness could be determined, depending on the type of ink used information on the expected volume loss/shrinkage could be supplied, or be available in a lookup table.

Various types of droplet ejection heads 60 may be suitable for use in the present embodiments. This may include those that eject all the fluid that is supplied to the head, and so-called through-flow or recirculation droplet ejection heads 60. Through-flow or recirculation heads are those where fluid circulates through the droplet ejection head 60 with a proportion of the fluid being drawn off and ejected out of the nozzles and the remainder exiting the droplet ejection head 60. Generally, the droplet ejection heads may comprise one or more nozzles wherein each nozzle is fluidically connected to a fluid chamber comprising one or more actuators that are actuable to eject one or more droplets of fluid via the nozzle in response to print instructions. Generally, one or more of the droplet ejection heads may have greyscaling capability and may be mounted into a droplet ejection apparatus 90,90′ as described herein or any other droplet ejection apparatus suitable for implementing the droplet ejection methods described herein for compensating for on-substrate fluid flow. Such droplet ejection apparatus may comprise one or more droplet ejection heads and one or more movement devices wherein said one or more droplet ejection heads may be mounted on said one or more movement devices. The droplet ejection apparatus may further comprise a fluid supply system 40,40′ or be connected to a separate fluid supply. The droplet ejection apparatus may further comprise one or more controllers 30 and or processors 35. Alternatively, the droplet ejection apparatus may be connected to one or more controllers 30 and or processors 35 for the exchange of control information and commands.

It may be generally understood that the fluid supply system 40,40′ may comprise one or more fluid reservoirs 41 adjacent to the droplet ejection heads 60 and or a fluid supply 20 located remotely from the droplet ejection heads 60 and connected to them via a fluid supply path 21 and, in the case of flow recirculation heads via a fluid return path 22. The fluid supply system 40,40′ may comprise one or more control devices 10 as depicted in FIG. 5, to control the pressure of the fluid in the one or more droplet ejection heads, depending on the requirements of the application.

It may be understood that prior to printing, print job data may be received and/or determined and/or calculated. The print job data may comprise information concerning the geometry of the substrate to be printed on (which may be a complex substrate), the image to be printed, the print resolution, the swath profiles and locations, the number of layers, and stitching requirements for the image, required fluid information, droplet ejection head movement profiles for the one or more droplet ejection heads 60. There may also be information concerning fluid requirements, fluid pressures, etc. as they may vary during the print process. It may be understood that the geometry of the substrate to be printed on may be CAD (Computer Aided Design) data, for example, or data generated using a surface mapping tool on an example of the substrate. The droplet ejection head movement profiles may comprise the droplet ejection head path, the droplet ejection head velocity, the droplet ejection head acceleration or deceleration and/or the droplet ejection head orientation, and hence may also comprise or be used to determine movement profiles for the movement apparatus 70,70′. Some or all of the print job data may be determined or calculated in the processor 35, alternatively some or all of the print job data may be provided to the processor 35, for example as one or more data files. The processor 35 may provide instructions to the controller 30. The compensated image data described herein may be provided as part of the print job data or it may be received and/or determined and/or calculated. For example, the uncompensated image data may be provided to the processor 35 and the compensated image data may be measured or determined or calculated as described herein in the processor 35.

It may be generally understood that the processor 35 and controller 30 may be arranged in any suitable configuration to enable the printing apparatus 90,90′ to operate and to perform the methods of addressing on-substrate fluid flow as described herein. For example, there may be one or more sub-controllers in addition to/instead of the controller 30 to control separate parts of the printing apparatus 90,90′ and/or some or all of the controller functionality may instead be incorporated into the processor 35. The controller 30 and/or sub-controller(s) may be a computing device, a microprocessor, an application-specific integrated circuit (ASIC), system on chip modules including processor elements and FPGA logic, or any other suitable device to control the functions of the various components of the printing apparatus 90,90′, for example the movement device 70 and/or the fluid supply system 40 and/or the one or more droplet ejection heads 60. The processor 35 may be, for example, a microprocessor or a computer.

As introduced above, various types of fluids may be used in the method. It may be generally understood that the fluid is a coating composition, e.g. a composition formulated as a fluid suitable for application to the substrate via the droplet ejection apparatus. Depending on the desired print application, for example, the fluid may be a water-borne coating composition or a solvent-borne composition. It may also be understood that the fluid may be formulated and used as a one-component (i.e., “1K”) composition or a two-component (i.e., “2K”) composition.

It may be generally understood that acceptable coating compositions comprise a binder, a crosslinker, and a carrier vehicle (e.g. a solvent, water, etc.). The term “binder” typically refers to film forming constituents of the coating composition. It may be understood that such binders can include specific polymers, oligomers, or combinations thereof that are often essential for forming coatings having desired properties, such as hardness, protection, adhesion, etc. Additional components, such as carriers, pigments, catalysts, rheology modifiers, antioxidants, UV stabilizers and absorbers, leveling agents, antifoaming agents, anti-cratering agents, or other conventional additives are typically not included in the term “binder” unless any of these additional components are film-forming constituents themselves. However, one or more of those additional components can be included in the coating composition as described below.

It may be understood that the binder is not particularly limited, and may comprise any suitable resin known and used in the type of coating compositions presented herein, e.g. solvent-borne and/or water-borne basecoats, monocoats, etc. For example, the resin may comprise an acrylic, a polyester, or combinations thereof. Alternatively, the composition, and/or the resin itself, may include a polyester and be free of an acrylic and/or any other polymer. The composition and/or the resin itself may include both an acrylic and a polyester and be free of any other polymer.

It may be generally understood that acceptable acrylics may be, include, consist essentially of, or consist of the reaction product of one or more of the following monomers: (meth)acrylamide, N-substituted (meth)acrylamide, octyl(meth)acrylate, nonylphenol ethoxylate(meth)acrylate, isononyl(meth)acrylate, 1,6-hexanediol(meth)acrylate, isobornyl(meth)acrylate, 2-(2-ethoxyethoxy) ethyl(meth)acrylate, 2-ethylhexyl(meth)acrylate, lauryl(meth)acrylate, beta-carboxyethyl(meth)acrylate, isobutyl(meth)acrylate, cycloaliphatic epoxide, alpha-epoxide, 2-hydroxyethyl(meth)acrylate, (meth)acrylonitrile, maleic anhydride, itaconic acid, isodecyl(meth)acrylate, dodecyl(meth)acrylate, n-butyl(meth)acrylate, methyl(meth)acrylate, hexyl(meth)acrylate, (meth)acrylic acid, N-vinylcaprolactam, stearyl(meth)acrylate, hydroxy functional caprolactone ester(meth)acrylate, octodecyl(meth)acrylate, isooctyl(meth)acrylate, hydroxyethyl(meth)acrylate, hydroxymethyl(meth)acrylate, hydroxypropyl(meth)acrylate, hydroxyisopropyl(meth)acrylate, hydroxybutyl(meth)acrylate, hydroxyisobutyl(meth)acrylate, tetrahydrofurfuryl(meth)acrylate, combinations of these, and the like.

For example, the acrylic may comprises one or more of(meth)acrylated urethanes (i.e., urethane(meth)acrylates), (meth)acrylated epoxies (i.e., epoxy(meth)acrylates), (meth)acrylated polyesters (i.e., polyester(meth)acrylates), (meth)acrylated (meth)acrylics, (meth)acrylated silicones, (meth)acrylated amines, (meth)acrylated amides; (meth)acrylated polysulfones; (meth)acrylated polyesters, (meth)acrylated polyethers (i.e., polyether(meth)acrylates), vinyl(meth)acrylates, and(meth)acrylated oils.

It may be generally understood that acceptable polyesters may be, include, consist essentially of, or consist of, any polyester known in the art. For example, the polyester may be linear or branched. Useful polyesters can include esterification products of aliphatic or aromatic dicarboxylic acids, polyols, diols, aromatic or aliphatic cyclic anhydrides and cyclic alcohols. Non-limiting examples of suitable cycloaliphatic polycarboxylic acids are tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic, and cyclobutanetetracarboxylic acid. The cycloaliphatic polycarboxylic acids can be used not only in their cis but also in their trans form and as a mixture of both forms. Further non-limiting examples of suitable polycarboxylic acids can include aromatic and aliphatic polycarboxylic acids, such as, for example, phthalic acid, isophthalic acid, terephthalic acid, halogenophthalic acids, such as, tetrachloro- or tetrabromophthalic acid, adipic acid, glutaric acid, azelaic acid, sebacic acid, fumaric acid, maleic acid, trimellitic acid, and pyromellitic acid. Combinations of polyacids, such as a combination of polycarboxylic acids and cycloaliphatic polycarboxylic acids can be suitable. Combinations of polyols can also be suitable.

It may be also understood that suitable can be conventionally polymerized from a monomer mixture containing a chain extender selected from the group of a hydroxy carboxylic acid, a lactone of a hydroxy carboxylic acid, and a combination thereof; and one or more branching monomers. Some of the suitable hydroxy carboxylic acids include glycolic acid, lactic acid, 3-hydroxypropionic acid, 3-hydroxybutyric acid, 3-hydroxyvaleric acid, and hydroxypyvalic acid. Some of the suitable lactones include caprolactone, valerolactone; and lactones of the corresponding hydroxy carboxylic acids, such as, e.g., 3-hydroxypropionic acid, 3-hydroxybutyric acid, 3-hydroxyvaleric acid, and hydroxypyvalic acid. Branched copolyester polymers can be produced by polymerizing, in one step, the monomer mixture that includes the chain extender and hyper branching monomers, or by first polymerizing the hyper branching monomers followed by polymerizing the chain extenders. Branched copolyester polymers formed from acrylic cores with extending monomers described above may also be used.

It may be generally understood that the term “crosslinker” refers to a component having “crosslinking-functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with the crosslinkable-functional groups (during the curing step) to produce a coating in the form of crosslinked structures. One of ordinary skill in the art would recognize that certain combinations of crosslinking-functional group and crosslinkable-functional groups would be excluded, since they would fail to crosslink and produce the film forming crosslinked structures.

In general, suitable coating compositions for use in or as the fluid comprise an isocyanate crosslinker, a melamine crosslinker, or both.

It may be generally understood that acceptable isocyanate cross-linker may be, include, consist essentially of, or consist of, one or more isocyanates such as, but not limited to, aromatic, aliphatic or cycloaliphatic di-, tri- or tetra-isocyanates, including polyisocyanates having isocyanurate structural units, such as, the isocyanurate of hexamethylene diisocyanate and isocyanurate of isophorone diisocyanate; the adduct of two molecules of a diisocyanate, such as, hexamethylene diisocyanate and a diol such as, ethylene glycol; uretidiones of hexamethylene diisocyanate; uretidiones of isophorone diisocyanate or isophorone diisocyanate; the adduct of trimethylol propane and meta-tetramethylxylene diisocyanate.

For example, isocyanates such as oligomers based on hexamethylene diisocyanate (HDI), diphenylmethane diisocyanate (MDI), isophorone diisocyanate (IPDI), or toluidine diisocyanate (TDI), e.g. isocyanurates, biuret, allophanates, and adducts of the isocyanates mentioned with polyhydric alcohols and mixtures thereof can be used. These can react with polyols such as, for example, OH group-containing polyesters, polyethers, acrylates and polyurethane, and mixtures thereof, which polyols may be solvent-based, solvent-free, or water-dilutable. Similarly, monofunctional isocyanates and/or blocked isocyanates may be utilized.

It may be generally understood that isocyanate cross-linkers may be used alone or in combination with a melamine cross-linker. Similarly, only melamine-type cross-linkers may be utilized in some applications. Melamine resins suitable as cross-linkers may be partially or fully etherified with one or more alcohols like methanol or butanol. A non-limiting example is hexamethoxymethyl melamine. Non-limiting examples of suitable melamine resins also include monomeric melamine, polymeric melamine-formaldehyde resin, or a combination thereof. The monomeric melamines include low molecular weight melamines which contain, on an average, three or more methylol groups etherized with a C1 to C5 monohydric alcohol such as methanol, n-butanol, or isobutanol per triazine nucleus, and have an average degree of condensation up to about 2, for example in the range of from about 1.1 to about 1.8, and have a proportion of mononuclear species not less than about 50 percent by weight. By contrast the polymeric melamines have an average degree of condensation of more than about 1.9. Some such suitable monomeric melamines include alkylated melamines, such as methylated, butylated, isobutylated melamines and mixtures thereof. Many of these suitable monomeric melamines are supplied commercially. For example, Cytec Industries Inc., West Patterson, N.J. supplies Cymel® 301 (degree of polymerization of 1.5, 95% methyl and 5% methylol), Cymel® 350 (degree of polymerization of 1.6, 84% methyl and 16% methylol), 303, 325, 327, 370 and XW3106, which are all monomeric melamines. Suitable polymeric melamines include high amino (partially alkylated, —N, —H) melamine known as Resimene® BMP5503 (molecular weight 690, polydispersity of 1.98, 56% butyl, 44% amino), which is supplied by Solutia Inc., St. Louis, Mo., or Cymel®1158 provided by Cytec Industries Inc., West Patterson, N.J. Cytec Industries Inc. also supplies Cymel® 1130@80 percent solids (degree of polymerization of 2.5), Cymel® 1133 (48% methyl, 4% methylol and 48% butyl), both of which are polymeric melamines.

It may be generally understood that the coating composition is typically a suspension of the film-forming components and optional additives, and thus generally comprises a carrier vehicle, e.g. a solvent or fluid. As introduced above, the carrier vehicles may be water-based or solvent-based, i.e., the coating composition is typically a water-borne composition or a solvent-borne composition. The formulations of such carrier vehicles are known in the art, and will be understood best in view of the examples and description herein.

Depending on application, the solvent may be an organic solvent. Examples of suitable organic solvents can include aromatic hydrocarbons, such as, toluene, xylene; ketones, such as, acetone, methyl ethyl ketone, methyl isobutyl ketone, methyl amyl ketone and diisobutyl ketone; esters, such as, ethyl acetate, n-butyl acetate, isobutyl acetate, and the like. Some specific examples include methanol, ethanol, isopropanol, n-butanol, 2-butanol, tridecyl alcohol, methyl isobutyl ketone, methyl ethyl ketone, 3-butoxy-2-propanol, ethyl 3-ethoxypropionate, butyl glycol, butyl glycol acetate, butanol, dipropylene glycol methyl ether, diethylene glycol monobutyl ether, butyl glycolate, hexane, heptane, octane, toluene, xylene, ethyl acetate, propyl acetate, isopropyl acetate, butyl acetate, isobutyl acetate, 2-butoxyethyl acetate, amyl acetate, isoamyl acetate, diethylene glycol butyl ether acetate, acetone, xylene, toluene. Typically, however, the coating composition is substantially free from highly volatile solvents, as well as any other types that would interfere with the type of applicator and application processes described herein.

When utilized, the organic solvent content is typically greater than about 50 wt. %, alternatively greater than 60 wt. %, alternatively greater than 70 wt. %, alternatively greater than 80 wt. %, or alternatively greater than 90 wt. %, based on a total weight of liquid carrier in the coating composition. However, any one solvent or carrier vehicle may be present in the coating composition in any suitable amount, e.g. from about 5 to about 70 wt. %, such as from about 10 about 65 wt. %, based on the total weight of the coating composition. The total amount of carrier utilized will depend on the type of composition (i.e., water-borne or solvent-borne), and will be understood in view of the solids content ranges provided herein.

In some applications, the coating composition comprises water as the carrier.

The coating composition can include various components, such as binders, dyes, rheology modifiers, carriers, catalysts, conventional additives, or combinations thereof. Conventional additives may include, but are not limited to, dispersants, antioxidants, UV stabilizers and absorbers, surfactants, wetting agents, leveling agents, antifoaming agents, anti-cratering agents, or combinations thereof. In some instances, the coating composition is suitable for use in the method on the basis that the coating composition includes certain components and/or includes certain components in a specific amount/ratio.

It may be generally understood that the coating composition may have a particular solids content, as indicated by the relative component amounts provided herein. Typically, the particular solids content of the coating composition will be selected in view of the other components present in the coating composition and used in the method. For example, the coating composition may be a solvent borne composition having a solids content of from about 25% to about 60%, such as from about 27% to about 55%, alternatively from about 30% to about 50%. Alternatively, the coating composition may be a water-borne composition having a solids content of from about 5% to about 45%, such as from about 8% to about 35%.

It may also be understood that the coating composition has a particular viscosity, such as a particular shear or complex viscosity, or another rheological property. One of skill in the art will appreciate the factors that influence the viscosity of the composition, including those involved in the method, as well as methods for determining particular viscosity and related values (e.g. ASTM 2196, etc.).

### EXAMPLES

The following examples, illustrating embodiments of this disclosure, are intended to illustrate and not to limit the embodiments of this disclosure as set forth in the claims.

All parts and percentages are reported on a weight basis unless otherwise indicated. If provided, molecular weights (both number and weight average molecular weight) referred to herein may be determined by conventional methods known in the art. For example, molecular weights for polyaspartate resins can be determined via gel permeation chromatography (GPC), e.g. using polystyrene standards and a tetrahydrofuran (THF) eluent. Unless otherwise indicated, molecular weights are reports as weight average molecular weight (Mw).

### Materials

Unless otherwise noted, all solvents, substrates, and reagents are purchased or otherwise obtained from various commercial suppliers (e.g. BASF, Covestro, Evonik, Sigma-Aldrich, VWR, Alfa Aesar, etc.) and utilized as received (i.e., without further purification) or as in a form used conventionally in the art.

Various coating compositions were prepared using the specific materials below:

| Component | Description |
|---|---|
| Melamine 1 | Melamine Cymel 303 |
| Melamine 2 | Melamine Cymel 325 |
| Melamine 3 | Highly methylated, n-butylated melamine crosslinker with a |
| | high degree of alkylation |
| Melamine 4 | Methylated, isobutylated, melamine formaldehyde resin with |
| | high degree of alkylation (hexaether) |
| Melamine 5 | Highly monomeric, methylated/iso-butylated melamine |
| | crosslinker with a high degree of alkylation |
| Polyol 1 | Polyol, PPG-425 |
| Polyurethane Dispersion 1 | Polyurethane dispersion resin formed from a linear polyester |
| | diol resin (reaction product of monomers 1,6-hexanediol, adipic |
| | acid, and isophthalic acid) and isophorone diisocyanate. About |
| | 35 wt. % solid |
| Polyurethane Dispersion 2 | Polyurethane dispersion resin formed from a slightly branched |
| | polyester polyol (equivalent weight ~485, hydroxyl content |
| | 3.5%) and hexamethylene diisocyanate, about 40 wt. % solid |
| Polyurethane Dispersion 3 | Polyurethane dispersion resin formed from a linear |
| | polycarbonate-polyester polyol (equivalent weight ~1000, |
| | hydroxyl content 1.7%) and isophorone diisocyanate. About 41 |
| | wt. % solid |
| Polyurethane Dispersion 4 | Polyester based polyurethane dispersion, 30-32 wt. % solid |
| Acrylic Resin 1 | High solids acrylic resin: 71% solids, 11% styrene, 21% BMA, |
| | 12% BA, 27% HPA |
| Acrylic Resin 2 | Si dispersion with acrylic resin dispersant |
| Acrylic Resin 3 | 45% solids acrylic resin dispersion, non-aqueous |
| Acrylic Resin 4 | 60% solids acrylic resin, Tg ~49° F. |
| Enamel Resin 1 | High-solids enamel resin, 60/40 BMA/HPA, 7000 Mw, in |
| | Aromatic Hydrocarbons (below) |
| Glycol Ether Polyester 1 | Glycol ether polyester, 80 wt. % solid, acid number ~7 |
| Styrene-Acrylic Latex | Styrene-acrylic latex dispersion is formed by a two-step |
| Dispersion 1 | emulsion polymerization process, 46 wt. % solid, Tg ~−7° C., |
| | acid number ~12, hydroxyl number ~7 |
| Polysiloxane Resin 1 | BYK 320, solution of 52% polyether modified methylalkyl |
| | polysiloxane/42.9% mineral spirit/5.1% propylene glycol |
| | monomethyl ether acetate |
| Hindered Amine 1 | Hindered amine light stabilizer (HALS), based on an amino- |
| | ether |
| Urethane Oligomer 1 | Low Tg Urethane Oligomer, 80% solids, 49% isocyanate, 7% |
| | cyclohexanol, 23% 2-ethyl hexanol |
| Silylated Oligomer | Silane acrylic polymer, 76% solids |
| Acrylosilane 1 | Dual-functional acrylosilane polymer, 8000 Mw, 70% solids |
| Acrylosilane 2 | Dual-functional acrylosilane polymer, 6500 Mw, 71% solids |
| Coating Additive 1 | Clearcoat additive based on 49° F. Tg acrylic resin, 60% solids |
| Coating Additive 2 | 10% solution DOWSIL 57 ADDITIVE in Aromatic |
| | Hydrocarbons (below) |
| Flow Additive 1 | Commercial flow additive |
| Flow Additive 2 | Acrylic copolymer flow additive, 50% solids in butyl acetate, |
| | 25% IBA, 25% IBMA |
| Black Pigment 1 | Dispersion of amorphous carbon black pigment, similar to a |
| | carbon black pigment, 28% solid |
| Black Pigment 2 | Dispersion of amorphous carbon black pigment, similar to a |
| | carbon black pigment, 17% solid |
| Black Pigment 3 | Dispersion of a black pigment |
| Catalyst 1 | DDBSA/AMP catalyst solution |
| Catalyst 2 | DDBSA/DIPA solution |
| UV Additive 1 | UV absorber |
| UV Additive 2 | UVA screener/HALS solution based on an amino-ether with |
| | benzotriazole |
| Levelling Additive 1 | Levelling additive |
| Wetting Agent 1 | Wetting agent, silicone free |
| Wetting Agent 2 | Wetting agent |
| Wetting Agent 3 | Solvent-free wetting and dispersing additive based on an |
| | alkylolammonium salt of an acidic polyester |
| Defoamer 1 | Defoamer |
| Rheology Additive 1 | HEUR thickener |
| Rheology Additive 2 | Acrylic alkali emulsion is commercially available from BASF |
| | Corporation of Florham Park, New Jersey under the tradename |
| | Rheovis ® AS 1130 |
| Rheology Additive 3 | Layered silicate rheology control agent is provided in a solution |
| | of water and polypropylene glycol which is similar to a solution |
| | commercially available from Altana under the trade name |
| | Laponite RD |
| Polyalcohols | Polyalcohols |
| N-Butyl Alcohol | N-butyl alcohol |
| Diethylene Glycol | Diethylene glycol monobutyl ether |
| Monobutyl Ether | |
| Ethylene Glycol | Ethylene glycol monobutylether |
| Monobutylether | |
| Water | Water |
| Mineral Spirit | Mineral spirit |
| High Boiling Point Alcohol | High boiling point alcohol |
| Amino Methyl Propanol | Amino methyl propanol |
| N,N- | N,N-Dimethylethanolamine |
| Dimethylethanolamine | |
| Trimethyl Orthoacetate | Trimethyl orthoacetate |
| Ethyl 3-Ethoxy Propionate | Ethyl 3-ethoxy propionate |
| Aromatic Hydrocarbons | Aromatic hydrocarbons, boiling point 140-200° C., density |
| | 0.8750 g/L @ 20° C. |

### Coating Compositions

A solvent-borne coating composition (SB1) was formulated and prepared using the components above. The particular components and paraments are shown in the table below.

| Component | Amount |
|---|---|
| Melamine 3 | 0.97 |
| Melamine 4 | 2.23 |
| Melamine 5 | 8.02 |
| N-Butyl Alcohol | 3.99 |
| Polysiloxane Resin 1 | 0.10 |
| Hindered Amine 1 | 0.28 |
| Flow Additive 2 | 0.28 |
| Catalyst 2 | 1.33 |
| Urethane Oligomer 1 | 8.42 |
| Trimethyl Orthoacetate | 2.19 |
| Acrylic Resin 1 | 2.01 |
| Coating Additive 1 | 15.77 |
| UV Additive 2 | 5.28 |
| Acrylic Resin 2 | 1.94 |
| Black Pigment 3 | 10.19 |
| Ethyl 3-Ethoxy Propionate | 1.29 |
| Silylated Oligomer | 4.60 |
| Acrylosilane 1 | 26.40 |
| Acrylosilane 2 | 4.71 |
| Total: | 100.00 |

Four additional solvent-borne coating compositions (SB2-SB5) were prepared using the components introduced further above. These compositions were formulated for overspray-free application according to the methods herein, and used in the Print Trials set forth below. The particular components and paraments of the solvent-borne compositions are shown in the table below.

| Coating Composition: | SB2 | SB3 | SB4 | SB5 |
|---|---|---|---|---|
| Melamine 4 | 20.67 | 20.44 | 18.84 | 15.33 |
| Aromatic Hydrocarbon | 19.67 | 10.59 | 23.98 | 29.19 |
| Wetting Agent 3 | — | — | — | 0.20 |
| Enamel Resin 1 | 51.45 | 34.95 | 43.81 | 21.57 |
| Acrylic Resin 3 | — | 19.53 | — | 14.65 |
| Acrylic Resin 4 | — | — | — | 2.93 |
| Coating Additive 2 | 0.06 | 0.06 | 0.05 | 0.05 |
| Catalyst 1 | 1.44 | 1.42 | 1.31 | 1.07 |
| UV Additive 2 | — | — | — | 4.89 |
| N,N-Dimethylethanolamine | — | — | — | 0.38 |
| Black Pigment 3 | 6.71 | 13.02 | 12.01 | 9.77 |
| Total: | 100.0 | 100.0 | 100.0 | 100.0 |

As formulated and prepared SB2 represents a single component solvent-borne mono-coat composition comprising a viscosity of 29.6 cP at 25° C. SB3 represents a single component solvent-borne base-coat composition comprising a viscosity of 42.5 cP at 25° C. SB4 represents a single component solvent-borne mono-coat composition comprising a viscosity of 64.9 cP at 25° C. SB5 represents a single component solvent-borne mono-coat composition comprising a viscosity of 30 cP at 25° C.

Water-borne coating compositions (WB) were formulated and prepared using the components set forth further above to give WB1-7. The particular components and parameters are shown in the table below.

| Component | WB1 | WB2 | WB3 | WB4 | WB5 | WB6 | WB7 |
|---|---|---|---|---|---|---|---|
| Melamine 1 | 3.29 | 3.70 | 2.35 | 2.35 | 2.35 | 2.35 | 1.12 |
| Melamine 2 | 0.63 | 0.70 | — | — | — | — | — |
| Polyol 1 | 0.91 | 1.02 | 0.14 | 0.14 | 0.14 | 0.14 | 0.07 |
| Polyurethane Dispersion 1 | 3.49 | 3.94 | 3.81 | 3.81 | 3.81 | 3.81 | 1.80 |
| Polyurethane Dispersion 2 | 4.62 | 5.19 | — | — | — | — | — |
| Glycol Ether Polyester 1 | — | — | 1.16 | 1.16 | 1.16 | 1.16 | 0.55 |
| Styrene-Acrylic Latex | 8.11 | 9.15 | 8.15 | 8.15 | 8.15 | 8.15 | 3.88 |
| Dispersion 1 | | | | | | | |
| Polyurethane Dispersion 3 | 1.67 | 1.88 | — | — | — | — | — |
| Polyurethane Dispersion 4 | 1.71 | 1.89 | — | — | — | — | — |
| Flow Additive 1 | 0.46 | 0.51 | — | — | — | — | — |
| Polyalcohols | — | — | 2.00 | 2.00 | 2.00 | 2.00 | 2.00 |
| N-Butyl Alcohol | 6.30 | 6.30 | — | — | — | — | — |
| Diethylene Glycol Monobutyl | 2.75 | 2.75 | — | — | — | — | — |
| Ether | | | | | | | |
| Ethylene Glycol | 1.28 | 1.20 | — | — | — | — | — |
| Monobutylether | | | | | | | |
| Water | 43.15 | 47.54 | 61.02 | 63.99 | 58.96 | 61.88 | 73.62 |
| Mineral Spirit | 1.00 | 1.00 | — | — | — | — | — |
| High Boiling Point Alcohol | — | — | 5.00 | 5.00 | 5.00 | 5.00 | 5.00 |
| Black Pigment 1 | 16.04 | 8.74 | — | — | — | — | — |
| Black Pigment 2 | — | — | 7.55 | 7.55 | 7.55 | 7.55 | 5.06 |
| Catalyst 1 | — | — | 0.14 | 0.14 | 0.14 | 0.14 | 0.07 |
| UV Additive 1 | — | — | 0.03 | 0.03 | 0.03 | 0.03 | 0.01 |
| Levelling Additive 1 | — | — | 2.00 | 2.00 | 2.00 | 2.00 | 2.00 |
| Wetting Agent 1 | — | — | 1.20 | 1.20 | 1.20 | 1.20 | 1.20 |
| Amino Methyl Propanol | — | — | 0.30 | 0.32 | 0.01 | 0.01 | 0.02 |
| N,N-Dimethylethanolamine | 0.14 | 0.13 | — | — | — | — | — |
| Wetting Agent 2 | 0.50 | 0.50 | — | — | — | — | — |
| Defoamer 1 | 1.95 | 2.02 | — | — | — | — | — |
| Rheology Additive 1 | — | — | — | — | 4.50 | 4.58 | 3.60 |
| Rheology Additive 2 | 2.00 | 1.84 | 2.16 | 2.16 | — | — | — |
| Rheology Additive 3 | — | — | 3.00 | — | 3.00 | — | — |
| Total: | 100.0 | 100.0 | 100.0 | 100.0 | 100.0 | 100.0 | 100.0 |

### General Print Method

A printhead is connected to a circulation system (Hydra) and mounted on a movable axis. A substrate is mounted to a movable axis perpendicular to the printhead. A coating composition is loaded into the printhead and applied while moving the substrate under the printhead at a selected speed (e.g. 50-150 mm/s) to lay down a first stripe. The printhead is then moved over 40-70 millimeters and the process repeated to lay down a second stripe, and give a continuous wet coating. The wet coating is allowed to flash undisturbed for up to 10 mins before being baked at 285 F for 30 minutes to provide a dried coating layer having a dry film thickness of 0.5-2.0 mils.

### Example 1: Image Compensation for Improved Sag Performance

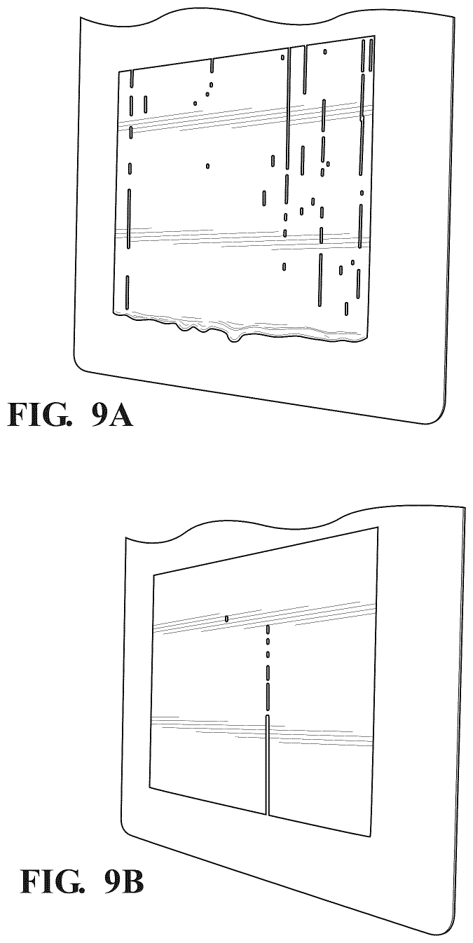

Coating composition SB5 set forth further above was selected for use in a print trial based on the general print method above. Specifically, SB5 was loaded into a Xaar 1003 printhead and applied to the substrate (flat, horizontal panel). The print conditions were selected for a 1080 DPI print at 50 mm/s, to achieve a dry film build of ~0.9 mil. The coated panel was then stood vertically to dry, and the resulting uncompensated layer was assessed visually. An illustration of an image of the dried uncompensated layer is shown in FIG. 9A.

The image data obtained from the dried uncompensated layer illustrated in FIG. 9A was used to determine compensated image data for another print of SB5, i.e., to compensate for the thickness build at the bottom of the panel due to sag of the coating composition. The compensated image data was then used to print a second substrate with SB5 and give a dried compensated layer thereon. An image of the dried compensated layer is illustrated in FIG. 9B. As evident from FIG. 9A and FIG. 9B, compensating for sag (i.e., by varying the printed fluid volume/wet layer thickness at the bottom/low portion of the panel) provided for less thickness variation across the stripe, as evidenced by fewer visual defects and minimal/no drips on the lower edge of the panel.

### Example 2: Image Compensation for Improved Overlap Performance/Reduced Visual Defects

Coating composition SB1 set forth further above was selected for use in another print trial based on the general print method above. A Xaar 2002 printhead comprising two groups of 500 nozzles each (i.e., 1000 nozzles total, grouped 1-500 and 501-1000), was positioned vertically for applying the coating composition in a downward fashion toward an upper surface of a substrate panel. The print conditions were selected for a 720 DPI print at 50 mm/s, to achieve a dry film build of ~1.3 mil.

Ten separate print runs were conducted to assess image compensation through varying the relative amount of fluid printed from each nozzle group during one or two passes over the same area of the substrate (i.e., where the second pass is printed onto the wet layer formed from the first pass). The relative amount of fluid applied from each nozzle group was selected from levels 0 (none/least) to 7 (most). Each of the coated substrates was then assessed visually for defects, and assigned a rating from 0 (low/poor) to 10 (high/optimal).

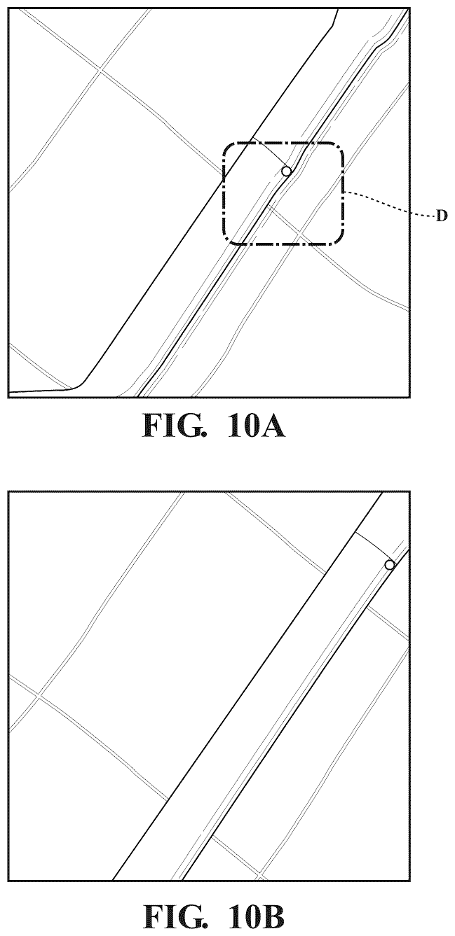

Examples of visual performance are shown in FIG. 10A and FIG. 10B, with FIG. 10A showing a representative light distortion (D) indicative of a defect on a dried layer resulting in a lower (negative) rating, and FIG. 10B showing a representative non-distorted light pattern indicative of a lesser/reduced defect on a dried layer resulting in a higher (positive) rating.

The parameters of the print runs are set forth in the table below, along with the assigned visual rating for the resulting coated substrate prepared.

| Print Run: | | 1 | 2 | 3 | 4 | 5 | 6 | 7 | 8 | 9 | 10 |
|---|---|---|---|---|---|---|---|---|---|---|---|
| Pass 1-Fluid Level | Nozzles 1-500: | 7 | 6 | 5 | 4 | 7 | 7 | 7 | 7 | 7 | 7 |
| | Nozzles 501-1000: | 0 | 1 | 2 | 3 | 1 | 2 | 3 | 4 | 6 | 5 |
| Pass 2-Fluid Level | Nozzles 1-500: | 0 | 1 | 2 | 3 | 0 | 0 | 0 | 0 | 0 | 0 |
| | Nozzles 501-1000: | 7 | 6 | 5 | 4 | 6 | 5 | 4 | 3 | 1 | 2 |

| | | | | | | | | | | |
|---|---|---|---|---|---|---|---|---|---|---|
| Visual Rating: | 0 | 2 | 8 | 8 | 9 | 5 | 3 | 4 | 7 | 4 |

As shown in the table above, runs were carried out using varying levels of fluid (paint) between passes 1 and 2. Run 1 accounts for a 100:0-0:100 ratio fluid level (e.g. volume/amount) per pass, and Runs 2-10 account for variations of this ration of from 85:15 to 15:85, such as volume/amount ratios between sequential runs of about 80:20, 75:25, 70:30,

Run 1 was carried out using an “on/off” approach, where in the first pass nozzles 1-500 fire level 7 paint and nozzles 501-1000 fire level 0 paint, and where in a second pass (over the same area) nozzles 1-500 fire level 0 paint and nozzles 501-1000 fire 7 paint. In this Run 1, the lowest visual rating was selected based on the observed defects.

Comparatively, Run 5 achieved the highest visual rating, and was performed with image compensation according to the present embodiments.

Accordingly, the present embodiments provide the method capable of achieving balanced printing performance (e.g. low sag, good flow and leveling) while maintaining good coating appearance characteristics. Specific implementations of the present embodiments may also provide superior performance and/or appearance over the comparative methods.

The data set forth shows that the exemplary compositions exhibit good performance and can be used prepare overspray free coatings in good order, with some exemplary coatings providing superior performance and appearance over the comparative coating compositions.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It is to be understood that various changes may be made in the function and arrangement of elements described in an exemplary embodiments above, without departing from the scope as set forth in the appended claims. Moreover, all combinations of the aforementioned components, compositions, method steps, formulation steps, etc. are hereby expressly contemplated for use herein in various non-limiting embodiments even if such combinations are not expressly described in the same or similar paragraphs.

With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the ranges and subranges enumerated herein sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. An individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims. Lastly, it will be understood that the term “about” with regard to any of the particular numbers and ranges described herein is used to designate values within standard error, equivalent function, efficacy, final loading, etc., as understood by those of skill in the art with relevant conventional techniques and processes for formulation and/or utilizing compounds and compositions such as those described herein. As such, the term “about” may designate a value within 10, alternatively within 5, alternatively within 1, alternatively within 0.5, alternatively within 0.1, % of the enumerated value or range.

While the present disclosure has been described with respect to particular embodiments thereof, it is apparent that numerous other forms and modifications will be obvious to those skilled in the art. The appended claims and this disclosure generally should be construed to cover all such obvious forms and modifications, which are within the true scope of the present disclosure.

1. A method of ejecting droplets of fluid to compensate for thickness variation due to on-substrate fluid flow of a dried uncompensated layer, comprising:
a. receiving uncompensated image data and a predefined nominal thickness;
b. determining a thickness variation from said predefined nominal thickness at one or more locations on a substrate of one or more dried uncompensated layers;
c. determining compensating image data to compensate for the thickness variation; and
d. ejecting droplets of fluid through one or more nozzles of a droplet ejection head using said compensating image data to form a dried compensated layer on said substrate.

2. The method according to claim 1, wherein the step b. of determining said thickness variation comprises:
i. ejecting droplets of fluid through one or more nozzles of a droplet ejection head using uncompensated image data to form one or more dried uncompensated layers on one or more substrates; and
ii. determining the thickness variation from the nominal thickness of said one or more dried uncompensated layers at one or more locations on said one or more dried uncompensated layers.

3. The method according to claim 2, wherein said fluid comprises a desired fluid.

4. The method according to claim 2, wherein said fluid comprises one or more test fluids.

5. The method according to claim 2, wherein said substrate comprises one or more test substrates.

6. The method according to claim 2, wherein said substrate comprises a desired substrate.

7. The method according to claim 2, wherein step ii. of determining the thickness variation comprises measuring the thickness and/or surface topography of said one or more dried uncompensated layers at one or more locations on said one or more dried uncompensated layers.

8. The method according to claim 1, wherein the step b. of determining said thickness variation comprises:
(i) calculating the thickness of said one or more dried uncompensated layers at said one or more locations using mathematical models;
(ii) using a lookup table or database to determine the thickness of said one or more dried uncompensated layers at said one or more locations based on said uncompensated image data and said substrate geometry; or
(iii) both (i) and (ii).

9. The method according to claim 1, wherein the step c. of determining compensating image data to compensate for thickness variation comprises adjusting the volume of fluid to be ejected at a given location.

10. The method according to claim 9, wherein adjusting said volume of fluid to be ejected at a given location comprises increasing or decreasing the volume of fluid to be ejected at said location.

11. The method according to claim 1, wherein the step c. of determining the compensating image data comprises:
(i) using a lookup table;
(ii) using a mathematical method;
(iii) determining the location of swathe joins and/or the orientation and/or curvature and/or other geometric features of a complex substrate;
(iv) using pattern-based volume alteration; or
(v) any combination of (i)-(iv).

12. The method according to claim 11, wherein for a swathe join:
the step c. of determining compensating image data to compensate for thickness variation between adjacent swathes comprises tapering the drop size and/or spacing over a portion of one or both swathes adjacent to the join; and/or
the step c. of determining compensating image data to compensate for thickness variation comprises printing half the volume over a portion of the swathe adjacent to the join in the initial swathe and half the volume over a portion of the swathe adjacent to the join in the subsequent swathe.

13. The method according to claim 1, wherein the fluid is a coating composition having a solids content of from about 5 to about 70%, and comprises:
a carrier;
a binder present in an amount of from 5 to about 70 wt. %, based on a total weight of the coating composition; and
a crosslinker present in an amount of from about 0.1 to about 25 wt. %, based on a total weight of the coating composition.

14. The method according to claim 13, wherein:
the fluid is further defined as a solvent borne coating composition having a solids content of from about 25% to about 60%.

15. A droplet ejection apparatus for implementing the method according to claim 1, comprising:
one or more droplet ejection heads; and
one or more movement devices,
wherein said one or more droplet ejection heads are mounted on said one or more movement devices.

16. The method according to claim 6, wherein the desired substrate is a vehicle component.

17. The method according to claim 13, wherein the fluid is further defined as a water borne coating composition having an initial solids content of from about 5% to about 45%.

18. The droplet ejection apparatus according to claim 15, wherein one or more of said one or more droplet ejection heads has greyscaling capability.
